(19) United States
(12) Patent Application Publication
(10) Pub. No.: US 2007/0071094 A1
(43) Pub. Date: Mar. 29, 2007

(54) Video encoding method, apparatus, and program

(76) Inventors: Naomi Takeda, Kawasaki-shi (JP); Takeshi Chujoh, Yokohama-shi (JP); Atsushi Matsumura, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/384,367

(22) Filed: Mar. 21, 2006

(30) Foreign Application Priority Data
Sep. 26, 2005 (JP) 2005-278044

(51) Int. Cl. H04N 11/04; H04N 7/12

(52) U.S. Cl. 375/240.04; 375/240.26

(57) ABSTRACT

A video encoding method includes encoding n pictures included in a video image using a first quantization parameter, calculating first number-of-encoded-bits information indicating number of encoded bits of every picture type, multiplexing a set frame rate by an average first-number-of-encoded-bits per picture calculated from the first-number-of-encoded-bits information to obtain a first bit rate, encoding the n pictures using a second quantization parameter, calculating second number-of-encoded-bits information indicating number of encoded bits of every picture type, multiplexing the set frame rate by an average second number-of-encoded-bits per picture calculated from the first-number-of-encoded-bits information to obtain a second bit rate, calculating a third quantization parameter, using the first bit rate, first quantization parameter, second bit rate, second quantization parameter and target bit rate, and performing the rate control using the third quantization parameter as an initial value.

### CROSS-REFERENCE TO RELATED APPLICATIONS

This application is based upon and claims the benefit of priority from prior Japanese Patent Application No. 2005-278044, filed Sep. 26, 2005, the entire contents of which are incorporated herein by reference.

### BACKGROUND OF THE INVENTION

1. Field of the Invention

The present invention relates to a rate control particularly in video encoding.

2. Description of the Related Art

Because motion picture data, i.e., video data have enormous quantity of data, compression encoding is carried out at the time of distributing or accumulating video data. At the time of compression encoding, it is required to encode the video data at a bit rate which is not over the transmission ability at the time of distributing, and to encode it at the number of bits which is not over a capacity which can be ensured at the time of accumulating. To cope with such a demand, a bit rate is controlled in video encoding by using a technique such as constant bit rate (CBR) control or variable bit rate (VBR) control, as is described in, for example, IDG information and telecommunications series MPEG-1/MPEG-2/MPEG-4 digital broadcasting textbook (First volume), IDG Japan, Inc. (Jan. 28, 2003) written by Wataru Kameyama and Tsuyoshi Hanamura. In CBR control, the entire set of sequences of an object video image is encoded at a constant bit rate every sequence. In VBR control, the entire set of sequences of the object video image is encoded at a different bit rate every sequence so that an average bit rate becomes a target bit rate.

These rate control systems are broadly classified into two. A rate control system in which an object video image is encoded by being scanned only once is called one-pass rate control. This is classified into one-pass CBR control and one-pass VBR control. In contrast, a rate control system in which the entire sequence of the object video image is scanned once and analyzed and then the number of bits allocated to each scene included in the sequence is determined on the basis of a result of analysis, is called two-pass rate control. This is classified into two-pass CBR control and two-pass VBR control.

In two-pass rate control, encoding cannot be started unless the image quality in the entire sequence of the object video image is known. Also, analysis processing as well as encoding processing is required at the time of encoding. For this reason, two-pass rate control cannot used for an application in which encoding is carried out in real time while receiving video data on the air. One-pass rate control is used for such an application.

At the time of carrying out one-pass rate control, the number of bits is allocated in units of group of pictures (GOP), and the number of bits per GOP is further allocated as the number of bits per picture in accordance with a global complexity measure of each picture. Encoding is carried out while adjusting a quantization parameter such that a divergence between the number of bits allocated in this way and the number of encoded bits at the time of actual encoding is not made great. At this time, the global complexity measure of an I picture is updated every time the I picture is encoded, and global complexity measures of P and B pictures are updated every time the P and B pictures are encoded.

On the other hand, Jpn. Pat. Appln. KOKAI Publication No. 2000-115786 discloses a method for preventing a deterioration in image quality by switching a quantization parameter in accordance with a difficulty level of encoding for each scene of a motion picture.

Because analysis on the object video image is not carried out in one-pass CBR control, a characteristic cannot be recognized whether the following image includes a rapid motion, is a still image, a flat image, or an image with a high resolution. Therefore, in one-pass CBR control, encoding taking the image quality in the entire sequence of the motion picture into account cannot be carried out. Further, the number of bits necessary for making the subjective image quality even differs greatly depending on a characteristic of an image. Accordingly, in CBR control for performing a control for making the number of bits for use in each picture image constant regardless of a characteristic of an image, a result of encoding in high image quality is not necessarily obtained.

In one-pass VBR control, on the other hand, analysis on the following image is not carried out in the same way as in a case of one-pass CBR control, and thus, it is difficult to achieve the high-quality image in consideration of a characteristic of an image. Moreover, in one-pass VBR control, a priority is given to prevention of the image quality from deteriorating, and it is not done to adjust an instant bit rate strictly to a target bit rate. Namely, control is made such that a value of a quantization parameter QP is not made to vary extremely. Therefore, when the sequence of the object video image is short, the convergence to a target bit rate is less, and there are cases in which the number of encoded bits does not fall within a desired number of bits.

On the other hand, in the technique in the Patent Document 1, the image quality easily deteriorates when there is a scene change such that a motion scene changes into a still image scene, or inversely, a still image scene changes into a motion scene. This is because allocation every a picture type is not necessarily appropriate even if a quantization parameter is determined on the basis of a degree of difficulty in encoding.

Moreover, assume that, at the time of carrying out one-pass rate control, there is performed processing in which the number of bits is allocated in units of GOP, and the number of bits per GOP is allocated as the number of bits per picture in accordance a global complexity measure of each picture of I, P, and B pictures. In this case, a frequency of updating I picture is less than those of P and B pictures at the time of updating a global complexity measure of each picture. Accordingly, there are cases in which the number of bits per picture is allocated by using a values of a global complexity measure which is not appropriate for I picture, which causes a problem that the number of bits to be allocated to I picture is not appropriate. Moreover, because a time difference between I picture and the following I picture is great, a change in the characteristics of the images is great among I pictures. For this reason, an accuracy of updating a global complexity measure of an I picture is low, which could be a cause of a deterioration in image quality.

### BRIEF SUMMARY OF THE INVENTION

An aspect of the present invention provides to A video encoding method for encoding a video image while doing a rate control so that a bit rate of encoded data nears a target bit rate, comprising: encoding n pictures included in a video image using a first quantization parameter to generate first encoded data; calculating first number-of-encoded-bits information indicating number of encoded bits of every picture type used for the encoding, using the first encoded data; multiplexing a set frame rate by an average first-number-of-encoded-bits per picture which is calculated from the first-number-of-encoded-bits information to obtain a first bit rate; encoding the n pictures included in the object video image using a second quantization parameter different from the first quantization parameter to generate second encoded data; calculating second number-of-encoded-bits information indicating number of encoded bits of every picture type used for the latter encoding, using the second encoded data; multiplexing the set frame rate by an average second number-of-encoded-bits per picture which is calculated from the first-number-of-encoded-bits information to obtain a second-bit rate;

calculating a third quantization parameter, using the first bit rate, the first quantization parameter, the second bit rate, the second quantization parameter and the target bit rate; and performing the rate control using the third quantization parameter as an initial value.

### BRIEF DESCRIPTION OF THE SEVERAL VIEWS OF THE DRAWING

FIG. 1 is a block diagram of a video encoding apparatus according to a first embodiment of the present invention;

FIG. 2 is a block diagram of a detailed encoder in which rate control is possible in FIG. 1;

FIG. 3 is a flowchart showing initial parameter setup procedures in the first embodiment of the invention;

FIG. 4 is a view showing one example of a group of pictures;

FIG. 5 is a view for explanation of an object video image sequence and positions of n pictures for use in calculation of the number of bits every picture type;

FIG. 6 is a view for explanation of an object video image sequence and positions of n pictures for use in calculation of the number of bits every picture type;

FIG. 7 is a flowchart showing initial parameter setup procedures in a second embodiment of the present invention;

FIG. 8 is a flowchart of the details of a step of calculating initial values of global complexity measures in FIG. 7;

FIG. 9 is a flowchart showing initial parameter setup procedures in a third embodiment of the present invention;

FIG. 10 is a block diagram of a video encoding apparatus according to a fourth embodiment of the present invention;

FIG. 11 is a flowchart showing initial parameter setup procedures in the fourth embodiment;

FIG. 12 is a view for explaining a relationship between a frame in which a scene change has been detected and a frame for use in setting of an initial parameter in the fourth embodiment;

FIG. 13 is a view for explaining a relationship between a frame in which a scene change has been detected and a frame for use in setting of an initial parameter in the fourth embodiment;

FIG. 14 is a block diagram of a video encoding apparatus according to a fifth embodiment of the present invention;

FIG. 15 is a flowchart showing initial parameter setup procedures in the fifth embodiment;

FIG. 16 is a flowchart showing the details of a step of determining a target bit rate per scene in FIG. 15;

FIG. 17 is a block diagram of a video encoding apparatus according to a sixth embodiment of the present invention;

FIG. 18A is a flowchart showing processing procedures in the sixth embodiment;

FIG. 18B is a flowchart showing processing procedures in the sixth embodiment;

FIG. 19 is a view for explaining one example of units of encoding in the sixth embodiment;

FIG. 20 is a view for explaining another example of units of encoding in the sixth embodiment;

FIG. 21 is a connection diagram in which intra-encoding is selected at the time of encoding in units of encoding in the sixth embodiment;

FIG. 22 is a connection diagram in which inter-encoding is selected at the time of encoding in units of encoding in the sixth embodiment;

FIG. 23 is a connection diagram at the time of encoding intra-slice in the sixth embodiment;

FIG. 24 is a connection diagram at the time of encoding inter-slice in the sixth embodiment;

FIG. 25A is a flowchart showing processing procedures in a case where the number of bits is assigned per picture, encoding is carried out in units of macro block, and updating of a virtual buffer occupancy and determination of a quantization parameter are carried out per picture, in the sixth embodiment;

FIG. 25B is a flowchart showing processing procedures in a case where the number of bits is assigned per picture, encoding is carried out in units of macro block, and updating of a virtual buffer occupancy and determination of a quantization parameter are carried out per picture, in the sixth embodiment;

FIG. 26 is a block diagram showing details of an intra-encoder in the video encoding apparatus according to the sixth embodiment;

FIG. 27 is a block diagram showing details of an intra-encoder in a video encoding apparatus according to a seventh embodiment of the present invention;

FIG. 28 is a block diagram showing details of an intra-encoder in a video encoding apparatus according to a modified example of the seventh embodiment of the invention; and

FIG. 29 is a block diagram of the video encoding apparatus according to the modified example of the seventh embodiment of the invention.

### DETAILED DESCRIPTION OF THE INVENTION

Hereinafter, embodiments of the present invention will be described in detail with reference to the accompanying drawings.

(First Embodiment)

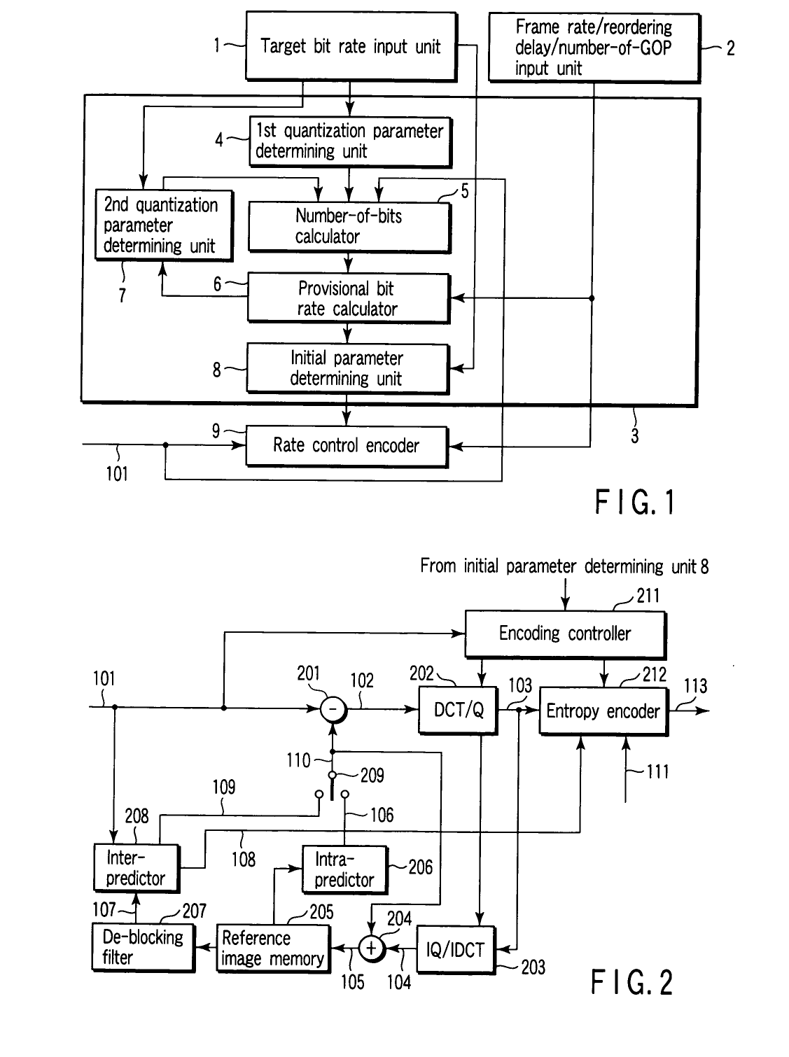

FIG. 1 shows a video encoding apparatus according to a first embodiment of the present invention, and the apparatus has a target bit rate (BR) input unit 1, a frame rate (FR)/reordering delay (M)/number-of-GOP input unit 2, an adaptive initial parameter determining unit 3, and a rate control encoder 9. The adaptive initial parameter determining unit 3 has a first quantization parameter (QP1) determining unit 4, a calculator 5 for calculating the number of encoded bits for every picture type (referred to as the number-of-bits calculator)), a provisional bit rate calculator 6 using the number of bits every picture type, a second quantization parameter (QP2) determining unit 7, and an initial parameter determining unit 8.

FIG. 2 shows the details of the rate control encoder 9 in FIG. 1. This example shows a principal part of a video encoder implemented in relation to H. 264. A video signal 101 which is an object to be encoded is inputted to a subtracter 201, and a predictive error signal 102 which is a finite difference between the video signal 101 and a predictive signal 110 is generated by the subtracter 201. DCT and quantization are applied onto the predictive error signal 102 by a discrete cosine transform (DCT)/quantization unit 202. Quantized DCT coefficient information 103 is inputted to a dequantization/inverse DCT unit 203 and an entropy encoder 212. Here, the DCT/inverse DCT is quoted as one example of orthogonal transformation/inverse orthogonal transformation, but not limited thereto.

The quantized DCT coefficient information 103 is processed by the dequantization/inverse DCT unit 203, and consequently, a signal 104 corresponding to the predictive error signal 102 is generated. The dequantization/inverse DCT unit 203 carries out inverse DCT and dequantization which are processing inverse to the processings of the DCT/quantization unit 202. The signal 104 outputted from the dequantization/inverse DCT unit 203 is added to a predictive signal 110 from a mode selection switch 209 in an adder 204, and consequently, a local decoded image signal 105 is generated. The local decoded image signal 105 is stored as a reference image signal in a reference image memory 205. A reference image signal having a plurality of frames is serially stored in the reference image memory 205.

The reference image signal read out of the reference image memory 205 is inputted to an intra-predictor 206 to generate an intra-predicted signal 106. The reference image signal is filtered by a de-blocking filter 207. A reference image signal 107 after filtered is inputted to an inter predictor (motion compensation predictor) 208. The inter-predictor 208 searches for a motion vector with respect to the reference image signal having a plurality of frames after filtered, and performs motion compensation on the basis of the searched motion vector, thereby generating motion vector information 108 and an inter predictive signal 109 per frame.

The mode selection switch 209 selects the intra-predictive signal 106 in an intra-predictive mode and selects the inter-predictive signal 109 in an inter-predictive mode, in accordance with encoding mode information (not shown) outputted from an encoding controller 211. The predictive signal 110 selected by the mode selection switch 209 is inputted to the subtracter 201.

In the entropy encoder 212, entropy encoding such as, for example, arithmetic encoding is subjected to the quantized DCT coefficient information 103, the motion vector information 108, and predictive mode information 111, so that variable-length codes 113 corresponding to the respective information 103, 108, and 111 are generated. The variable-length codes 113 are provided as data for syntax to a multiplexer at a subsequence stage (not shown), and an encoded bit stream is generated due to the data being multiplexed. The encoded bit stream is smoothed by an output buffer (not shown), and then transmitted to a transmission system or an accumulation system (not shown).

The encoding controller 211 receives an initial parameter from the initial parameter determining unit 8 shown in FIG. 1, and makes, for example, a control of quantization parameters in the DCT/quantization unit 202 and the IDCT/dequantization unit 203, and a control of the entropy encoder 212 in order to control an encoded bit rate.

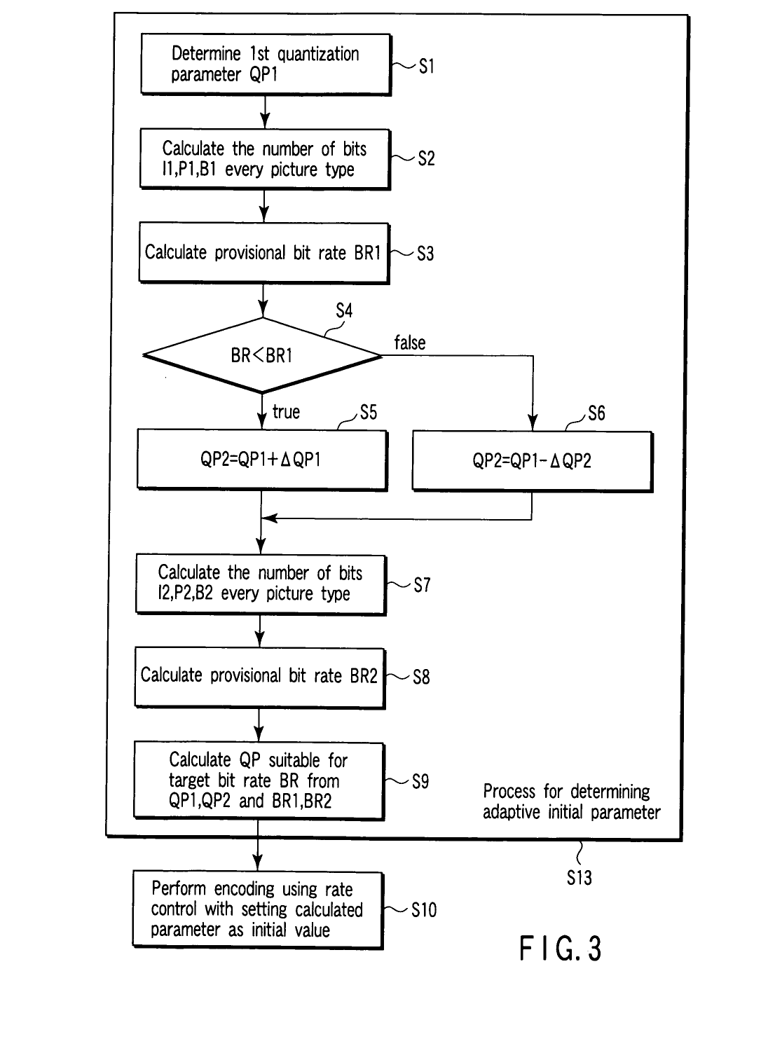

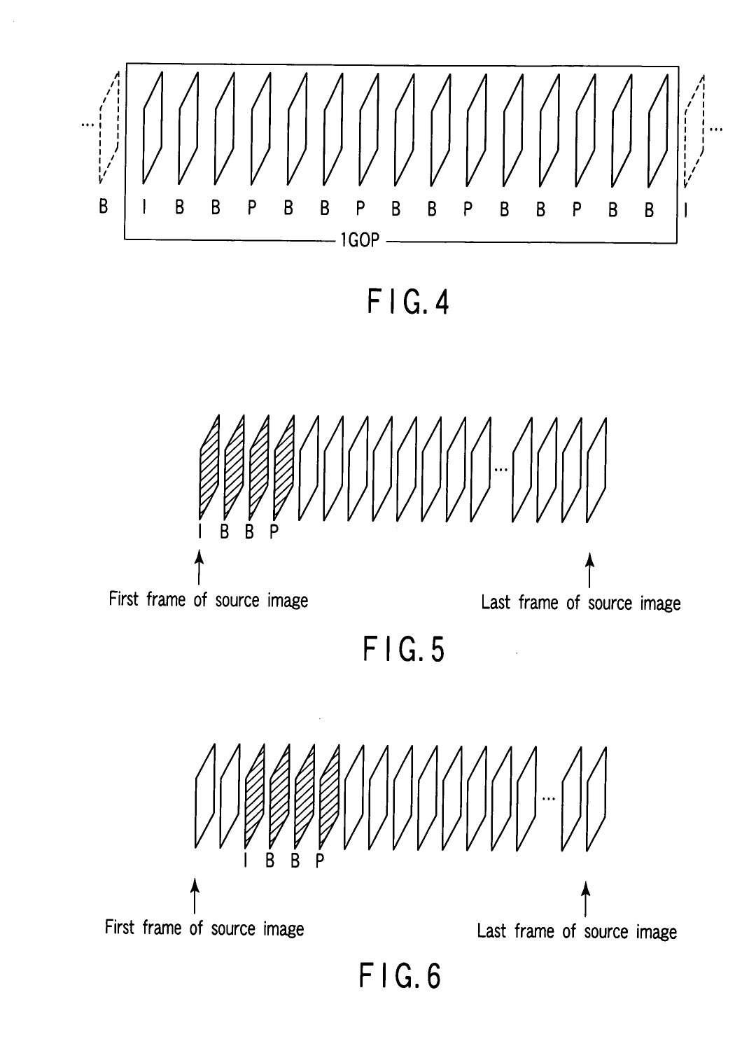

Next, initial parameter setup procedures in the present embodiment will be described with reference to FIG. 3. In the following descriptions, the video signal 101 which is an object to be encoded is called an object video image. At the time of setting an initial parameter, the object video image 101 is inputted to the adaptive initial parameter determining unit 3, information on a target bit rate (BR) is inputted from the input unit 1, and information on a setting frame rate (FR), a reordering delay (M), and the number (N) of group of pictures (GOP) of the object video image 101 are inputted from the input unit 2. The reordering delay is a cycle in which I picture or P picture appears. The fact that the reordering delay is M means that M−1 B pictures follow I picture or P picture. The GOP expresses an aggregation of N pictures of a total of I pictures, P pictures, and B pictures from I picture possessing the object video image 101 up to the following I picture. For example, a GOP in a case of M=3 and N=15 is shown in FIG. 4. Here, in FIG. 4, pictures are arranged in displaying order starting from the left.

In the adaptive initial parameter determining unit 3, first, the 1st quantization parameter determining unit 4 determines a 1st quantization parameter QP1 (step S1). In this case, the quantization parameter QP1 may be determined in accordance with an input of a user, or QP1 may be determined on the basis of the number of encoded bits per pixel. To quote one example of the latter method, bit rate/(frame rate×the number of pixels per picture) is calculated to determine a quantization parameter in accordance with a calculated result thereof, as described in, for example, Siwei Ma; Wen Gao; Feng Wu; Yan Lu; Image Processing, 2003, Processings. 2003 International Conference on, Volume 3, 14-17 Sep., 2003, Pages: III-793-6 vol. 2.

Next, by using the quantization parameter QP1 determined in this way, the number-of-bits calculator 5 calculates the numbers of bits I1, P1 and B1 every picture type, which are information showing the number of encoded bits per picture, i.e., the number of encoded bits per picture, every picture type for use in encoding (step S2). Here, the number of bits I1 every picture type denotes the number of bits of I picture, the number of bits P1 every picture type denotes the number of bits of P picture, and the number of bits B1 every picture type denotes the number of bits of a B picture.

As well known already, in MPEG-2, I picture is a picture encoded without reference to another picture, P picture is a picture encoded with reference to a timewise past picture among encoded I and P pictures, and B picture is a picture with reference to pictures before and after timewise among encoded I and P pictures. In H. 264, a slice is defined as an encoding unit which is smaller than a picture. There are I slice encoded with reference to only an encoded portion of an encoding object slice, P slice encoded with reference to at most one of only encoded I and P slices, and B slice encoded with reference to at most two of encoded I and P slices. Although there is a difference between H. 264 and MPEG-2, there is a similar characteristic in a case where 1 slice is made to be 1 picture, and thus, they will be described as I picture, P picture, and B picture in the following descriptions.

It is described above that B1 is calculated. However, when B pictures are not used at the time of actual encoding (namely, when the reordering delay M is 1), calculation of B1 is unnecessary. In the same way, when entire encoding is carried out with I pictures (namely, when GOP N is 1), calculation of P1 is unnecessary.

One method for calculating the numbers of bits I1, P1, and B1 every picture type is a method for actually encoding pictures included in the object video image 101. For example, the method is to carry out encoding onto the first n pictures in a video sequence by the quantization parameter QP1. This makes it possible to determine at least the numbers of encoded bits I1, P1, and B1 per picture with respect to I pictures, P pictures, and B pictures. The minimum value of n at this time is determined on the basis of a value of the reordering delay M.

Since the first picture is encoded as I picture and the next picture is encoded as P picture when the reordering delay M is 1, it suffices for at least two pictures from the top of the object video image to be encoded. Assume that the first picture in the object video image is encoded to be I picture when the reordering delay M is 3. In this case, next, the fourth picture is encoded to be P picture, and next, the second picture and the third picture are successively encoded to be B pictures. Accordingly, it suffices for at least n=4 pictures from the top of the object video image to be encoded. Namely, among the frames in the object video image shown in FIG. 5, only the first four frames shown with shaded in FIG. 5 are actually encoded by the quantization parameter QP1, and encoding of the other frames with QP1 (accordingly, analysis on the image) is not carried out.

In the above description, the example in which M+1 pictures are encoded (n=M+1) has been explained. However, (k×M+1) pictures are encoded (n=k×M+1), and the numbers of encoded bits of pictures in a same type may be averaged to calculate the number of encoded bits every picture type. Hereinafter, an example in which M+1 pictures are encoded (n=M+1) will be explained.

Here, explanation has been given to the case where one frame is encoded as one picture. However, a case where one frame is divided into two fields, and one field is encoded as one picture may be in the same way. This also applies to the other embodiments which will be described later.

In addition to the method for checking the number of encoded bits by actually encoding by a quantization parameter QP1, there may be used a method for estimating the number of encoded bits on the basis of the number of zero coefficients obtained at the time of quantization by a quantization parameter QP1 with respect to a DCT coefficient obtained at a step of completing the processing up to DCT which is at the middle stage of encoding. This method has been reported in, for example, Z. He, Y. K. Kim, Sanjit. K. Mitra “Low-Delay Rate Control for DCT Video Coding via p-domain Source Modeling”, IEEE Transactions on Circuits and Systems for Video Technology, Vol. 11, No. 8, oag. 928-940, August 2001. In case of using this method, it suffices to estimate the number of encoded bits for a DCT coefficient obtained at a stage of completing the processing up to DCT in only the frames shaded in FIG. 5.

The number of bits of I picture and the number of bits of P picture which have been determined in this way are respectively made to be I1 and P1, and an average of the numbers of bits of two B pictures, or a larger number of bits or a smaller number of bits is made to be B1. Here, it is important in the present embodiment to calculate the numbers of bits I1, P1 and B1 every picture type from n pictures, for example, the first n pictures of the object video image. A method itself for calculating I1, P1 and B1, such as the numbers of bits are determined by actually carrying out encoding, and the numbers of bits are determined by using an approximation based of a number of zero coefficients, is not limited.

Next, a provisional bit rate (first bit rate) BR1 is calculated in the provisional bit rate calculator 6 by use of the numbers of bits I1, P1 and B1 every picture type which are calculated as described above in the number-of-bits calculator 5, and information on the setting frame rate FR inputted from the input unit 2 (step S3). For example, at the thought of a case where one frame is encoded as one picture, a provisional bit rate BR1 is calculated as follows.

$$BR 1 = \frac{I 1 + P 1 ⨯ ( \frac{N}{M} - 1 ) + B 1 ⨯ \frac{N}{M} ⨯ ( M - 1 )}{N} ⨯ FR \qquad ( 1 )$$

where, as described above, M denotes a reordering delay; N denotes the number of GOPs; and FR denotes a frame rate.

On the other hand, in a case where one field is encoded as one picture, a provisional bit rate BR1 is calculated as follows.

$$BR 1 = \frac{I 1 + P 1 ⨯ ( \frac{2 ⨯ N}{M} - 1 ) + B 1 ⨯ \frac{2 ⨯ N}{M} ⨯ ( M - 1 )}{N} ⨯ FR \qquad ( 2 )$$

In this way, a provisional bit rate BR1 is determined by multiplying the setting frame rate FR to the average number of encoded bits per picture which is determined by the numbers of bits I1, P1 and B1 every picture type (the left sides on the right-hand sides in equation (1) or (2)).

Next, in the 2nd quantization parameter determining unit 8, the provisional bit rate BR1 calculated as described above and the target bit rate BR inputted from the target bit rate input unit 1 are compared (step S4), and a second quantization parameter QP2 is determined in accordance with a result thereof (steps S5 to S6). Namely, when the provisional bit rate BR1 is larger than the target bit rate BR, a value which is greater by ΔQP1 than the QP1 is set as QP2 in step S5, and in other cases, a value which is less by ΔQP2 than the QP1 is set as QP2 in step S6. Here, ΔQP1 and ΔQP2 are used for setting QP2 such that BR2 obtained by using QP2 is made to be close to BR or to be greater than BR2 when BR1 is less than BR, and for setting QP2 such that BR2 is made to be close to BR or to be less than BR1 in reverse case.

Subsequently, the numbers of bits I2, P2 and B2 every picture type are calculated in the number-of-bits calculator 5 by use of the Q2 determined in the 2nd quantization parameter determining unit 8 (step S7). In step S7, I2, P2 and B2 are determined from the frames shaded of FIG. 5 in the same way as in step S2.

Next, a provisional bit rate BR2 is calculated in the provisional bit rate calculator 6 by use of formula (3) or (4) which is the same as formula (1) or (2) for calculating BR1, on the basis of the numbers of bits I2, P2 and B2 every picture type which are calculated in step S7, the frame rate FR inputted from the input unit 2, and the reordering delay M and the number of GOPs N (step S8).

$$\begin{matrix}BR 2 = \frac{I 2 + P 2 ⨯ ( \frac{N}{M} - 1 ) + B 2 ⨯ \frac{N}{M} ⨯ ( M - 1 )}{N} ⨯ FR & ( 3 ) \\ BR 2 = \frac{I 1 + P 2 ⨯ ( \frac{2 ⨯ N}{M} - 1 ) + B 2 ⨯ \frac{2 ⨯ N}{M} ⨯ ( M - 1 )}{N} ⨯ FR & ( 4 )\end{matrix}$$

More specifically, in the same way as in equation (1) or (2), a bit rate BR2 is determined by multiplying the setting frame rate FR to the average number of encoded bits per picture which is determined by the numbers of bits I2, P2 and B2 every picture type (the left side on the right-hand side in equation (3) or (4)).

A quantization parameter QP is determined in the initial parameter determining unit 7 on the basis of the QP1, QP2, BR1, BR2, and the target bit rate BR (step S9). As a method for determining a quantization parameter QP, a method can be conceived as one example in which interpolation or extrapolation calculation as the following equation is carried out on the assumption that a logarithm of a bit rate BR is in linear relationship of QP=a×log(BR)+b with respect to a quantization parameter QP.

$$QP = a ⨯ log ( BR ) + b \\ a = \frac{QP 2 - QP 1}{log ( BR 2 ) - log ( BR 1 )} \\ b = \frac{QP 1 \cdot log ( BR 2 ) - QP 2 \cdot log ( BR 1 )}{log ( BR 2 ) - log ( BR 1 )} \qquad ( 5 )$$

However, it suffices to calculate a quantization parameter QP which is estimated to be suitable for a bit rate BR by using the relationship between QP1 and BR1, and QP2 and BR2, and a method for calculating QP is not limited to formula (5) in particular.

Further, the above-described example has explained that n pictures from the first frame are encoded as in FIG. 5 (the example in which the first picture is I picture). However, when the encoding efficiency for each picture is taken into account, encoding is not carried out in this way, the first M−1 pictures are made to be P pictures, and the M-th picture is made to be I picture in many cases. In consideration of this, it is preferable to calculate the number of bits every picture type in accordance with such a GOP structure.

For example, in a case of FIG. 6, all the picture types (I picture, P picture, and B picture) for use in encoding appear in the four frames (four pictures) from the third frame to the sixth frame which are counted from the first frame of the object video image. Then, as shown in FIG. 6, it can be conceived of that the numbers of bits every picture type are calculated on the basis of the characteristics of the images in the four frames (four pictures) from the third frame to the sixth frame. As described above, there are cases in which, taking into account the encoding efficiency, the first frame of the object video image is not made to be I picture, but the first two frames are made to be P pictures and I picture follows it, in the final encoding. In such a case, the positions of I pictures correspond to one another in the way in which n pictures for use in calculation of the numbers of bits every picture type are set as in FIG. 6 more than the way of setting as in FIG. 5. Thus, it is possible that the image quality of the final encoded image is improved.

In the above description, the numbers of bits every picture type are calculated by use of the first n pictures of the object video image. However, in reality, it suffices to calculate rough values of the numbers of bits of the object video image. Accordingly, the numbers of bits every picture type may be calculated by using the images of n pictures in the middle thereof if there is no change in the screen.

The present embodiment has described the example in which, when two quantization parameters are used, bit rates are calculated on the basis of information on the number of bits showing the numbers of encoded bits every picture type for use in encoding, and a third quantization parameter is determined on the basis of two combinations of pairs of the quantization parameters and the bit rates, and a target bit rate. However, a method is allowed which uses a quantization parameter on the basis of pairs of three or more quantization parameters and bit rates thereof, and a target bit rate.

In this case, a quantization parameter for use in the encoding is estimated on the basis of three or more pairs of quantization parameters and bit rates thereof, and a target bit rate, but an estimating method thereof can be conceived in various ways.

One estimating method is a method for selecting two pairs from among three or more pairs, and applying the above-described mathematical equation (5) to the two pairs, and another estimating method is a method for determining an approximated curve by use of a least square method or the like on the basis of the relationship between the three or more pairs of quantization parameters and bit rates, thereby estimating a quantization parameter suitable for a target bit rate on the approximated curve.

A method for selecting two pairs from among three or more pairs of quantization parameters and bit rates can be conceived in various ways.

For example, there are a method in which a quantization parameter QP_A corresponding to a bit rate BR_A which is closest to a target bit rate, and a quantization parameter QP_B corresponding to a bit rate BR_B which is second-closest to the target bit rate are selected; and a method in which, when there are a quantization parameter QP_C corresponding to a bit rate BR_C which is greater than a target bit rate, and a quantization parameter QP_D corresponding to a bit rate BR_D which is less than the target bit rate, the two quantization parameters QP_C and QP_D, the bit rates BR_C and BR_D, and the target bit rate are selected. It does not depend on the present invention how to select.

At the last, encoding is carried out by using rate control in the rate control encoder 9 by using a quantization parameter initial value QP determined in step S9 by the initial parameter determining unit 7 (step S10). When a quantization parameter initial value QP is not set appropriately in accordance with a characteristic of an image, there is a problem that the image quality deteriorates until the quantization parameter is made stable. According to the present embodiment, an initial parameter QP suitable for a characteristic of an object video image and a target bit rate BR is calculated and set in advance, so that such an initial deterioration in image quality can be avoided.

(Second Embodiment)

Next, a second embodiment of the present invention will be described. In the second embodiment, not only the quantization parameter initial value QP, but also an initial value of a global complexity measure is determined in the initial parameter determining unit 7 of FIG. 1.

Hereinafter, a global complexity measure will be explained. A global complexity measure is a parameter used in a system employed in TM5 of MPEG-2. With respect to TM5, a model is assumed in which the product of an average quantization parameter and the number of encoded bits is a constant value every picture type unless an image changes. In the following equation, X is a global complexity measure every picture type, S is the number of bits every picture type, and Q is an average quantization parameter every picture type.

$$\begin{matrix}{X}_{i} = {S}_{i} {Q}_{i} \\ {X}_{p} = {S}_{p} {Q}_{p} \\ {X}_{b} = {S}_{b} {Q}_{b}\end{matrix} \} \qquad ( 6 )$$

In rate control of TM5, bit allocation of the following picture is carried out by use of values of global complexity measures Xi, Xp and Xb every I picture, P picture and B picture shown in equation (6). In accordance with this bit allocation, a quantization parameter QP is adjusted every macro block in order for the number of encoded bits per picture to not deviate from a specified value. Namely, bit allocations of the respective I, P and B pictures at the time of starting encoding are determined by the initial values of Xi, Xp and Xb. The initial values of Xi, Xp and Xb are selected as follows in TM5.

$$\begin{matrix}{X}_{i} = \frac{160 ⨯ BR}{115} \\ {X}_{p} = \frac{60 ⨯ BR}{115} \\ {X}_{b} = \frac{42 ⨯ BR}{115}\end{matrix} \} \qquad ( 7 )$$

Equation (7) shows that, given that the number of encoded bits of I picture is 160, the number of encoded bits of P picture is about 60 and the number of encoded bits of B picture is about 42. In a still image or an image with small motion which is closed thereto, the number of encoded bits of I picture is extremely greater than the numbers of encoded bits of P picture and B picture. In contrast thereto, in an image with large motion, there is, in some cases, scarcely a difference between the number of encoded bits of P picture and the number of encoded bits of I picture. Accordingly, when encoding is started with initial values as equation (7), initially, image quality deteriorates. As the number of pictures of an object to be encoded increases, the value of X is updated, resulting in gradually making the image quality stable.

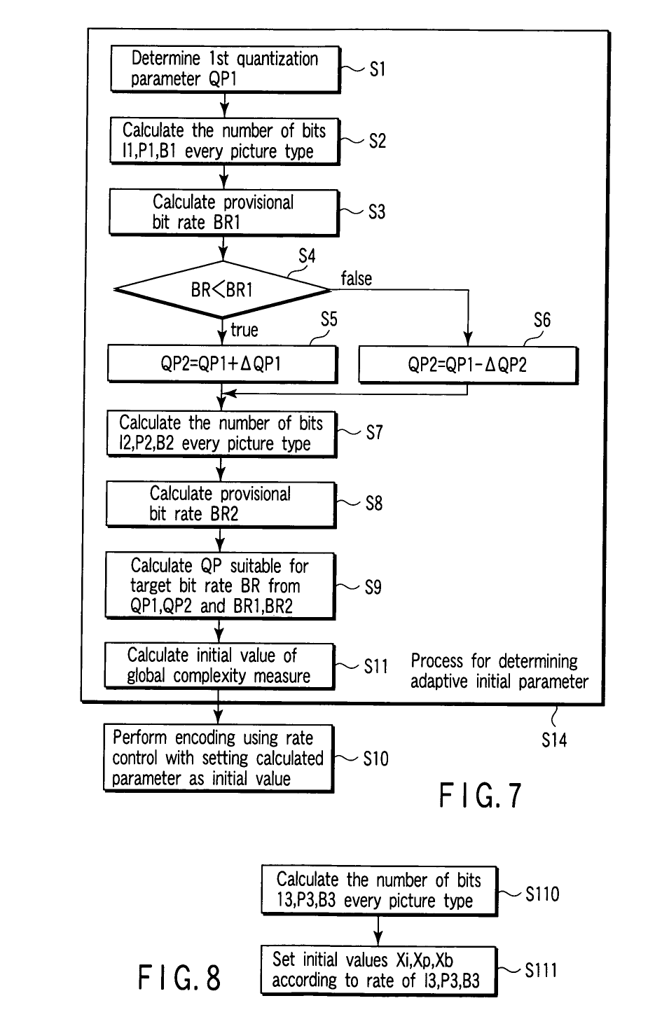

In the second embodiment of the present invention, initial values of X are not made to be constant values which do not depend on an image as equation (7), but are determined adaptively in accordance with a characteristic of an image. Namely, adaptive initial parameter determining processing S14 shown in FIG. 7 is carried out in the video encoding apparatus shown in FIG. 1. In FIG. 7, processing in step S11 is added to the adaptive initial parameter processing S13 in the first embodiment shown in FIG. 3. Unlike the first embodiment, the initial parameter determining unit 7 and the rate control encoder 9 carry out operations as follows.

In the initial parameter determining unit 7, a quantization parameter QP is first determined in the same way as in the first embodiment (step S9). Next, initials values of global complexity measures Xi, Xp and Xb by the quantization parameter QP are calculated (step S11). As one concrete method in step S11, the numbers of bits I3, P3 and B3 every picture type are calculated by use of the quantization parameter QP (step S110), and initial values of Xi, Xp and Xb are determined so as to correspond to ratios of I3, P3 and B3, as shown in, for example, FIG. 8 (step S111).

A method for calculating the numbers of bits every picture type in step S110 is the same as the method in step S2 described in the first embodiment. More specifically, for example, the numbers of encoded bits when encoding is carried out every picture type with respect to the first n pictures of an object video image are used. That is, only the frames shaded in FIG. 5 are encoded by the quantization parameter QP. The numbers of encoded bits of I picture and P picture at this time are respectively made to be I3 and P3, and an average value, a maximum value, or a minimum value of the numbers of bits of two B pictures is made to be B3.

The initial values of global complexity measures Xi, Xp and Xb are determined so as to correspond to ratios of the numbers of bits I3, P3 and B3 every picture type which are obtained in this way. Then, the rate control encoder 9 carries out encoding of the object video image by setting an initial value of the quantization parameter QP and the initial values of Xi, Xp and Xb. In this manner, the initial values of global complexity measures suitable for the characteristic of a starting video image of an object video image and encoding QP are set, and consequently, stable image quality can be obtained immediately after encoding is started.

Here, although explanation has been given to the case where images to be analyzed at the time of calculating I3, P3 and B3 are the four frames shaded in FIG. 5, they may be the four frames shaded in FIG. 6. Further, description has been made to the example in which the numbers of bits I3, P3 and B3 every picture type are calculated by using the same quantization parameter QP for I, P and B pictures. However, the numbers of bits I3, P3 and B3 every picture type may be calculated in such a manner that the quantization parameters for the P picture and B picture, or the quantization parameter for the B picture is made greater than the quantization parameter QP for the I picture. Because a frequency that I picture is referred is higher than those of P picture and B picture, it is generally considered that the entire image quality is more improved when the image quality of I picture is improved as compared with the case of P and B pictures. Accordingly, it is effective to change a quantization parameter in accordance with a picture type.

(Third Embodiment)

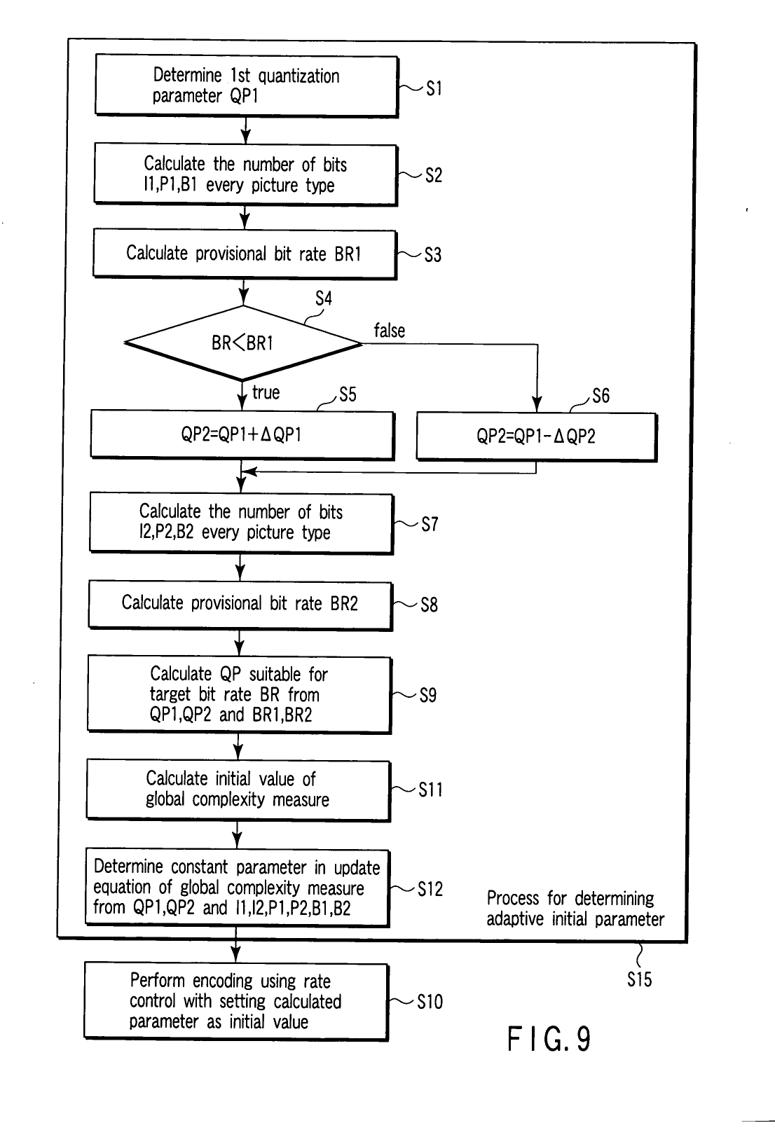

Next, a third embodiment of the present invention will be described. In the present embodiment, adaptive initial parameter determining processing S15 shown in FIG. 9 is carried out in the video encoding apparatus shown in FIG. 1. In FIG. 9, processing in step S12 is further added to the adaptive initial parameter determining processing S14 in the second embodiment shown in FIG. 7.

More specifically, in the third embodiment, a quantization parameter QP suitable for the target bit rate BR is first calculated in the initial parameter determining unit 7 shown in FIG. 1 in the same way as in the second embodiment (step S9). Next, initial values of global complexity measures are calculated by using the QP in the same way as in the second embodiment (step S11). Thereafter, constant parameters in the updating equations of the global complexity measures are determined on the basis of the quantization parameters QP1 and QP2, and the numbers of bits I1, I2, P1, P2, B1 and B2 every picture type (step S12).

The second embodiment has described the model (TM5 of MPEG-2) in the case where there is the relationship shown in equation (6) between the global complexity measures every picture type, and the numbers of bits every picture type and the average quantization parameters every picture type. However, a case in which the model is different depending on a video encoding system is possible. For example, a model in which, when the quantization parameter QP increases by 6, the number of encoded bits is reduced by half is used in H. 264. Then, to rewrite the equations for updating global complexity measures Xi, Xp and Xb so as to correspond to the model in H. 264, the equations are as follows.

$$\begin{matrix}{X}_{i} = {S}_{i} \cdot {C}_{i} {Q}_{i} \\ {X}_{p} = {S}_{p} \cdot {C}_{p} {Q}_{p} \\ {X}_{b} = {S}_{b} \cdot {C}_{B} {Q}_{b}\end{matrix} \} \qquad ( 8 )$$

In this case, CI, CP and CB in equation (8) are calculated as follows on the basis of the values of QP1, QP2, I1, I2, P1, P2, B1 and B2.

$$\begin{matrix}{C}_{I} = {2}^{\frac{log ( I 1 ) - log ( I 2 )}{Q 2 - Q 1}} \\ {C}_{P} = {2}^{\frac{log ( P 1 ) - log ( P 2 )}{Q 2 - Q 1}} \\ {C}_{B} = {2}^{\frac{log ( B 1 ) - log ( B 2 )}{Q 2 - Q 1}}\end{matrix} \} \qquad ( 9 )$$

There is the trend that the values of CI, CP and CB vary in accordance with a solution of an image, a value of the quantization parameter QP and a size of temporal change in an image. Accordingly, by setting the values of CI, CP and CB so as to correspond to a characteristic of the first picture of an object video image, updating of global complexity measures suitable for the characteristic of the image is carried out unless the image changes, which makes the image quality stable.

(Fourth Embodiment)

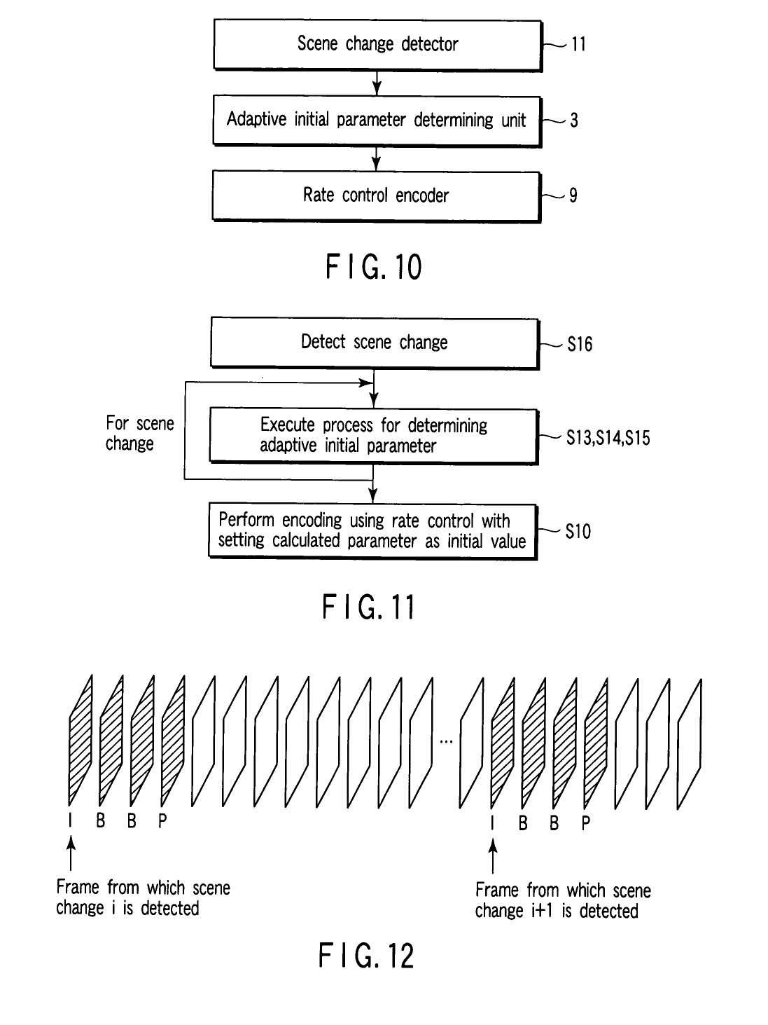

FIG. 10 is a video encoding apparatus according to a fourth embodiment of the present invention, and a scene change detector 11 is added to FIG. 1. The scene change detector 11 detects, for example, (a) a state in which a difference between pixels in a current frame and a previous frame of an object video image, (b) a state in which an object video image is changed from a motion scene to a still image, and (c) a state in which an object video image starts to move from a still image, as a scene change in an object video image. Not only a typical scene change as in the state (a), but also changes of the existence or nonexistence of motion as in (b) and (c) can be great changes in parameters in rate control. Then, a deterioration in image quality due to a scene change is prevented by adaptively determining a parameter in a scene (frame) in which such a scene change has been brought about. The adaptive initial parameter determining unit 10 determines an adaptive initial parameter with respect to a scene from which such a scene change has been detected, so as to correspond to all scene changes detected by the scene change detector 11.

In the present embodiment, a scene change is first detected in step S16 in accordance with processing procedures shown in FIG. 11. Then, adaptive initial parameter determining processing shown in S13 of FIG. 3, S14 of FIG. 7, or S15 of FIG. 9 is carried out onto the scene from which a scene change has been detected. Next, with an initial parameter calculated so as to correspond to a scene change being as an initial value every scene change, encoding is carried out by using rate control (step S10). More specifically, a quantization parameter QP suitable for, for example, the target bit rate BR is determined with respect to at least one scene detected by the scene change detector 11. The rate control encoder 9 carries out encoding by using the determined quantization parameter QP when encoding of detected scene is started.

In addition to use of the quantization parameter QP determined with respect to a scene from which a scene change has been detected, initial values of global complexity measures, or moreover, values of constant parameters for use in the equations for updating global complexity measures may be determined in the adaptive initial parameter determining unit 10.

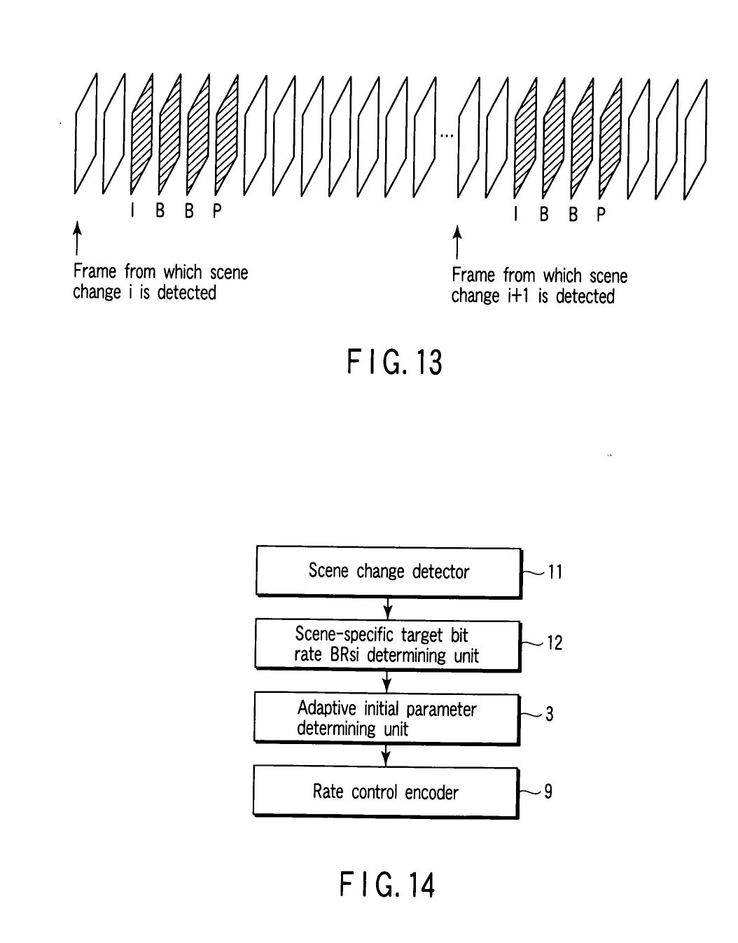

At the time of determining an adaptive initial parameter according to a scene change, analyzeanalyzes are performed on n frames from the first frame in which a scene change has been brought about. For example, when a reordering delay M is 3, analyzeanalyzes are applied to four frames from a frame from which a scene change i has been detected, and four frames from a frame from which a scene change i+1 has been detected (the frames shaded in FIG. 12), as shown in FIG. 12. Adaptive initial parameters are respectively determined with respect to the scene i and the scene i+1. Further, as shown in FIG. 13, M+1 frames from the M-th frame counted from a frame from which a scene change i or i+1 has been detected, i.e., given that M=3, four frames from the third frame to the sixth frame may be used for analyzeanalyzes for setting adaptive initial parameters.

In accordance with the present embodiment, a parameter suitable for the characteristic of the image can be set when a scene change occurs, such as a change in which (a) a scene of an object video image greatly changes, (b) an object video image changes from a still image to a motion image, and (c) an object video image changes from a motion image to a still image. Consequently, it is possible to make the image quality after a scene change stable.

(Fifth Embodiment)

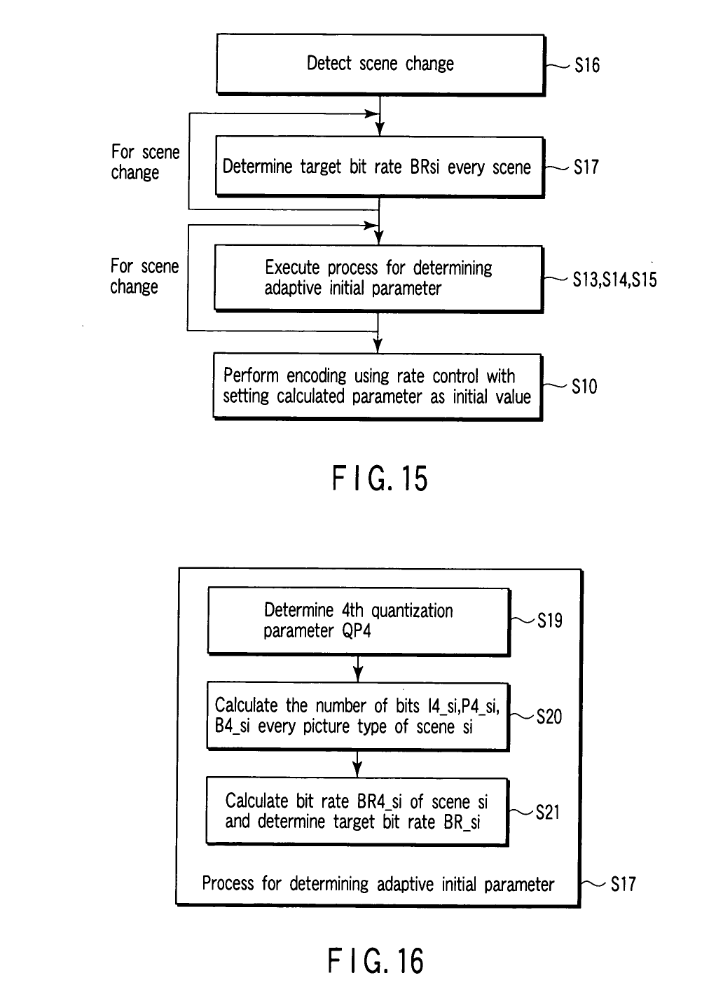

FIG. 14 shows a video encoding apparatus according to a fifth embodiment of the present invention, and a scene-specific target bit rate determining unit 12 is further added to the configuration of FIG. 11. In the processing procedures in the present embodiment, as shown in FIG. 15, a scene change of an object video image is detected in the scene change detector 11 in step S16, and thereafter, a target bit rate BRsi of the scene from which a scene change has been detected is determined in the target bit rate determining unit 12 (step S17). Next, the adaptive initial parameter determining unit 10 receives, in place of the target bit rate BR, the BRsi determined with respect to the detected scene change in step S17, and carries out the adaptive initial parameter determining processing in S13 of FIG. 3, S14 of FIG. 7, or S15 of FIG. 9. Subsequently, with an initial parameter determined so as to correspond to a scene change being as an initial value every scene change, encoding is carried out by using rate control (step S10).

Here, a method for determining a target bit rate BRsi in a scene si in step S17 can be conceived in various ways. As the simplest method, the procedures shown in FIG. 16 are used. First, a given fourth quantization parameter QP4 is determined (step S19), and the numbers of bits I4_si, P4_si, and B4_si every picture type of scene si are calculated based on QP4 (step S20). A method for determining QP4 in step S16 may be the same as the method for determining the first quantization parameter QP1 in the first embodiment. A method for calculating I4_si, P4_si, and B4_si in step S20 may be the same as the method for calculating I1, P1 and B1 in the first embodiment.

Next, a bit rate BR4_si in a scene si is calculated, and moreover, a target bit rate BRsi in a scene si is determined (step S21). At this time, the number of frames of the scene Si is defined to be FNUM_si. Suppose that the total of FNUM_si corresponds to the number of frames FNUM of the object video image as follows.

$${\sum }_{i = 0}^{n} FNUM\_si = FNUM \qquad ( 10 )$$

In step S21, the bit rate BR4_si in the scene si is calculated as follows on the basis of the values of bit rates I_si, P_si, and B_si.

$$BR 4 \_si = \frac{I\_si + P\_si ⨯ ( \frac{N}{M} - 1 ) + B\_si ⨯ \frac{N}{M} ⨯ ( M - 1 )}{N} ⨯ FR \qquad ( 11 )$$

Moreover, in step S21, the target bit rate BRsi in the scene si is determined as follows by multiplying BR4_si by a ratio of the bit rate in the entire object video image and the target bit rate.

$$BR\_si = BR4\_si ⨯ \frac{BR}{{\sum }_{i = 0}^{n} BR4\_si ⨯ \frac{FNUM\_si}{FNUM}} \qquad ( 12 )$$

The target bit rate BRsi in the scene si determined in this way is, in place of the target bit rate BR, inputted to the adaptive initial parameter determining unit 10, whereby adaptive initial parameter determining processing is carried out with respect to each scene change (step S13, S14, or S15 of FIG. 15). After the adaptive initial parameters with respect to respective scene changes obtained in this way are set every scene, encoding using rate control is carried out (step S10 of FIG. 15).

(Sixth Embodiment)

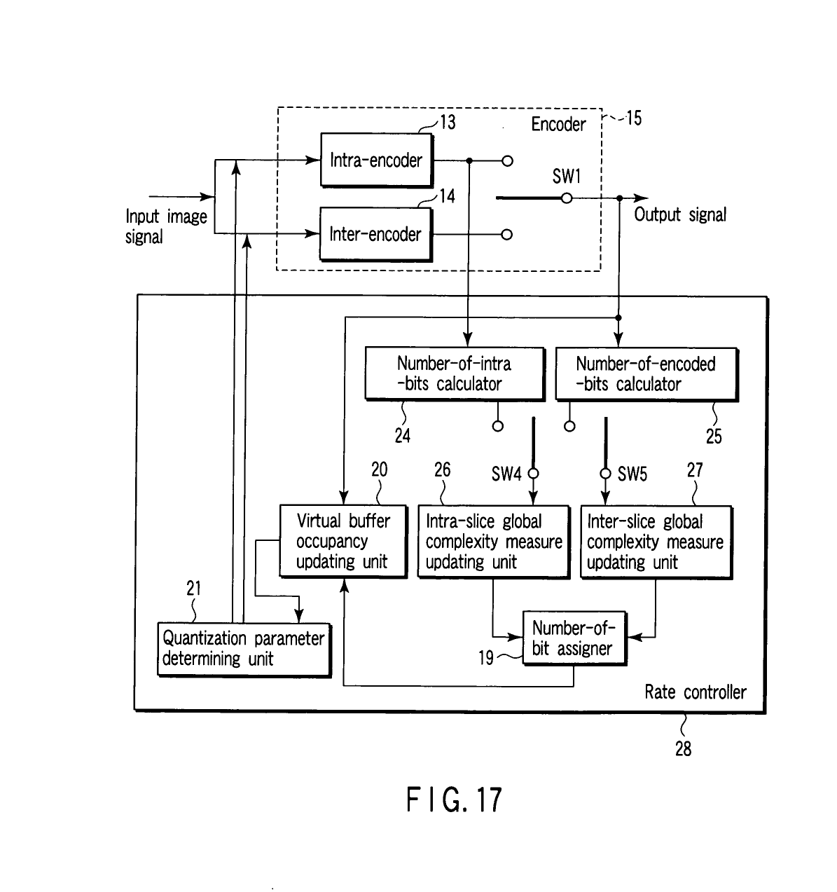

A video encoding apparatus according to a sixth embodiment of the present invention shown in FIG. 17 is configured by an encoder 15 and a rate controller 28 broadly divided. The encoder 15 has an intra-encoder 13, an inter-encoder 14, and an encoding mode selection switch SW1. The switch SW1 is used for selecting an encoding mode, i.e., for taking an output signal of the encoder 15 out of any of the outputs by switching the output of the intra-encoder 13 and the output of the inter-encoder 14.

The intra-encoder 13 and the inter-encoder 14 comprehensively express portions in the rate control encoder shown in FIG. 2 respectively relating to a function of intra-encoding and a function of inter-encoding. For example, the intra-encoder 13 expresses a portion having a function of carrying out encoding by use of an intra-predictive signal 106 generated by the intra-predictor 206 in FIG. 2. In the same way, the inter-encoder 14 expresses a portion having a function of carrying out encoding by use of an inter-predictive signal 109 generated by the inter-predictor 208. In FIG. 2, the components other than the intra-predictor 206, the blocking filter 207, and the inter-predictor 208 are in common to those in the intra-encoder 13 and the inter-encoder 14.

The rate controller 28 has a number-of-bits assigner 19, a virtual buffer occupancy updating unit 20, a quantization parameter determining unit 21, a calculator 24 of calculating the number of intra-bits every slice (referred to as number-of-intra-bits calculator), a calculator 25 of calculating the number of encoded bits every slice (referred to as number-of-encoded-bits calculator hereinafter), an intra-slice global complexity measure updating unit 26, an inter-slice global complexity measure updating unit 27, and switches SW4 and SW5. The switch SW4 is used for switching an output of the slice-specific number-of-intra-bits calculator 24, and an output of the slice-specific number-of-encoded-bits calculator 25 to be inputted to the intra-slice global complexity measure updating unit 26. The switch SW5 is used for switching between an output of the slice-specific number-of-intra-bits calculator 24 and an input of the inter-slice global complexity measure updating unit 27.

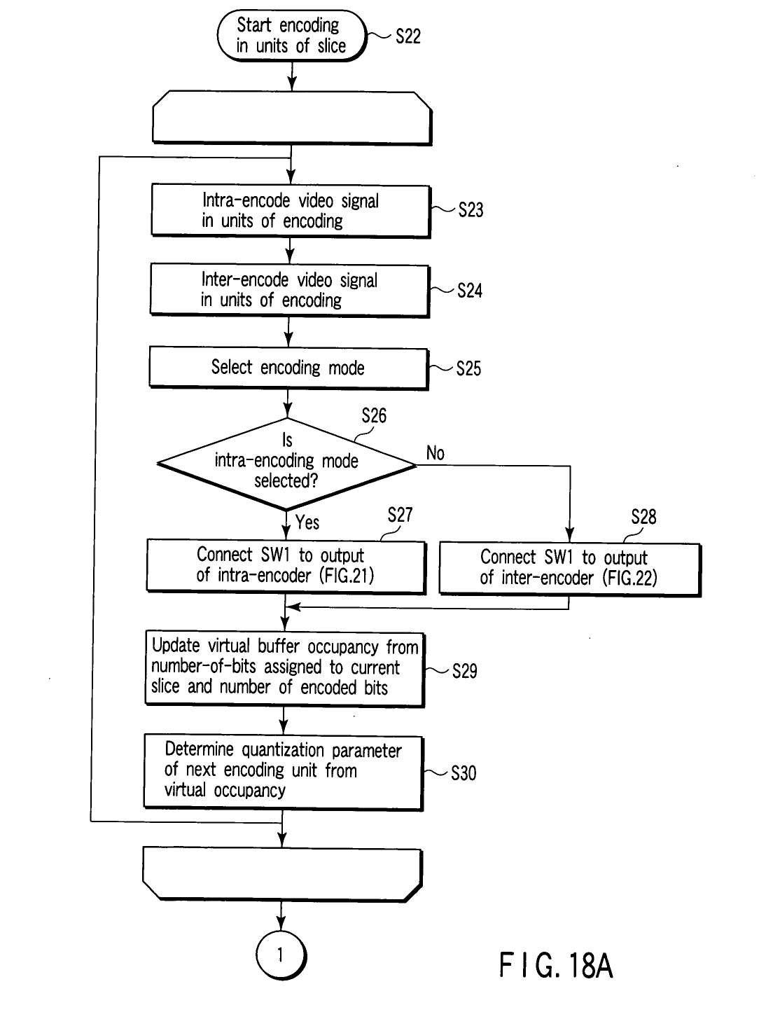

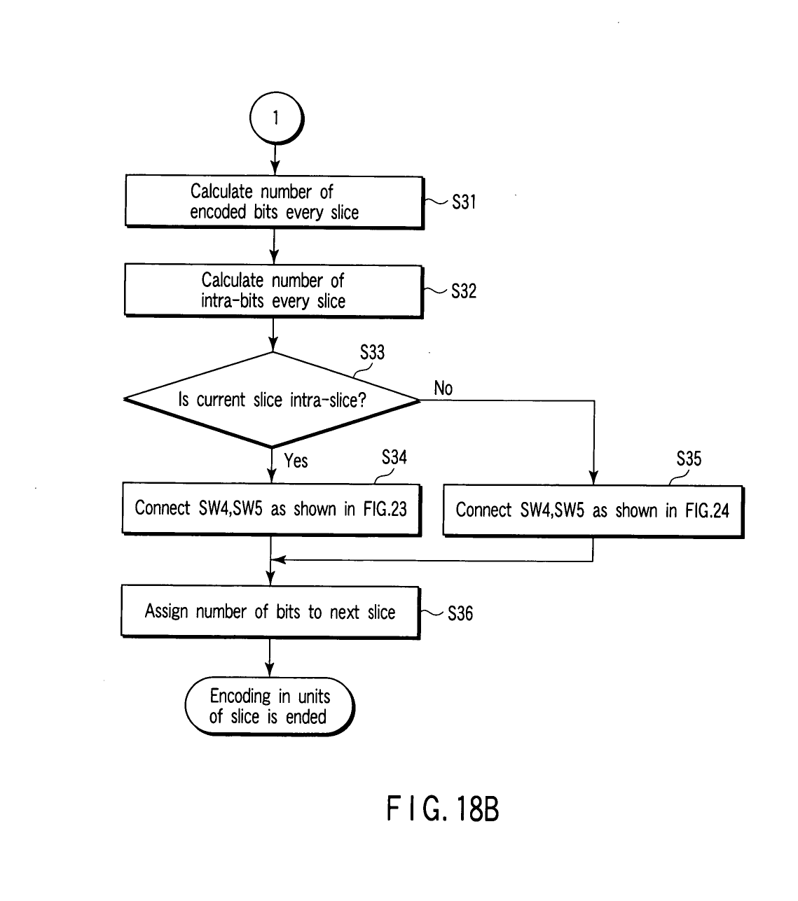

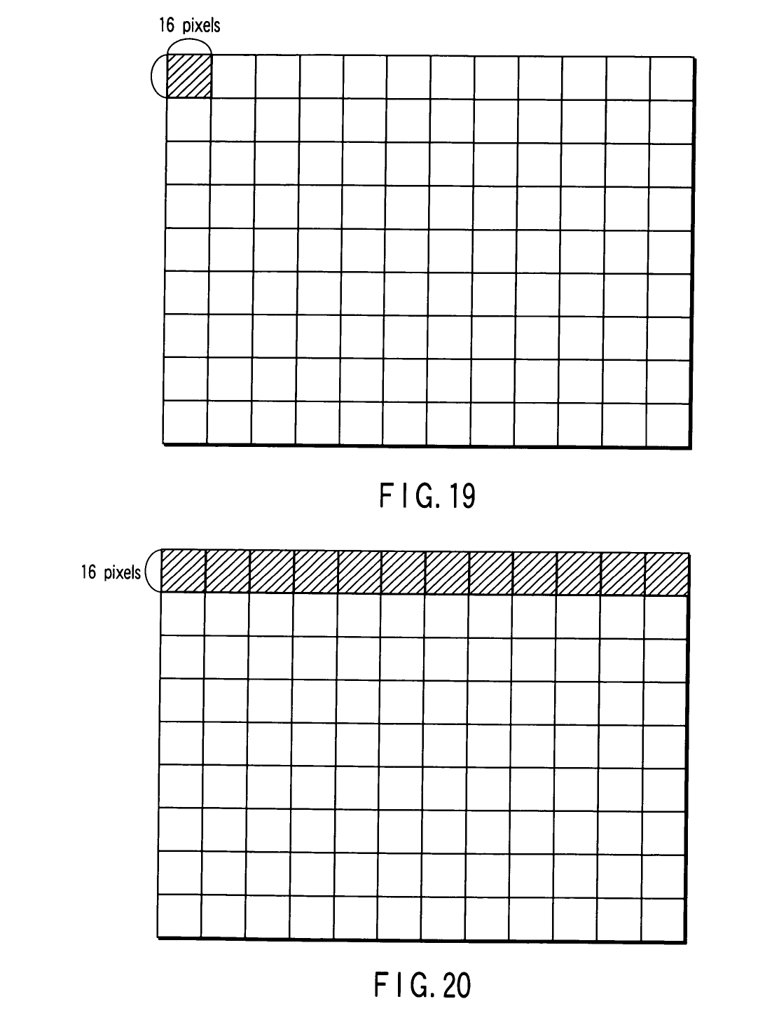

The flow of the processing will be described with reference to FIGS. 18A and 18B. When encoding every slice is started in step S22, an input video signal is inputted to the intra-encoder 13 and the inter-encoder 14 of the encoder 15, whereby intra-encoding and inter-encoding are carried out in certain encoding units (steps S23 to S24). Encoding units for intra-encoding and inter-encoding are parts of an input video signal, and for example, they are a unit of 256 pixels of 16.times.16 pixels shaded in FIG. 19, or a unit from the extreme right of column 16 pixels on the screen to the extreme left on the screen shaded in FIG. 20. In this way, an encoding unit and an encoding order can be conceived in various ways, but not limited thereto in the present embodiment in particular.

A quantization parameter for use in encoding is determined at the quantization parameter determining unit 21. Namely, a quantization parameter is determined by feedback control such that the number of encoded bits is decreased at the time of next encoding when the number of encoded bits from a point in time encoding is started is greater than a target value, and the number of encoded bits is in creased in the reverse case. In this way, the number of bits is assigned in one or more encoding units, and a quantization parameter is determined so as to reduce a difference between the assignment and an actual number of encoded bits.

A unit of assigning the number of bits is set separately from the encoding unit described above. Here, a unit of assigning the number of bits is called a slice. A slice in which intra-encoding is carried out onto an entire slice is called an intra-slice, and a slice in which inter-encoding is carried out onto an entire slice is called an inter-slice.

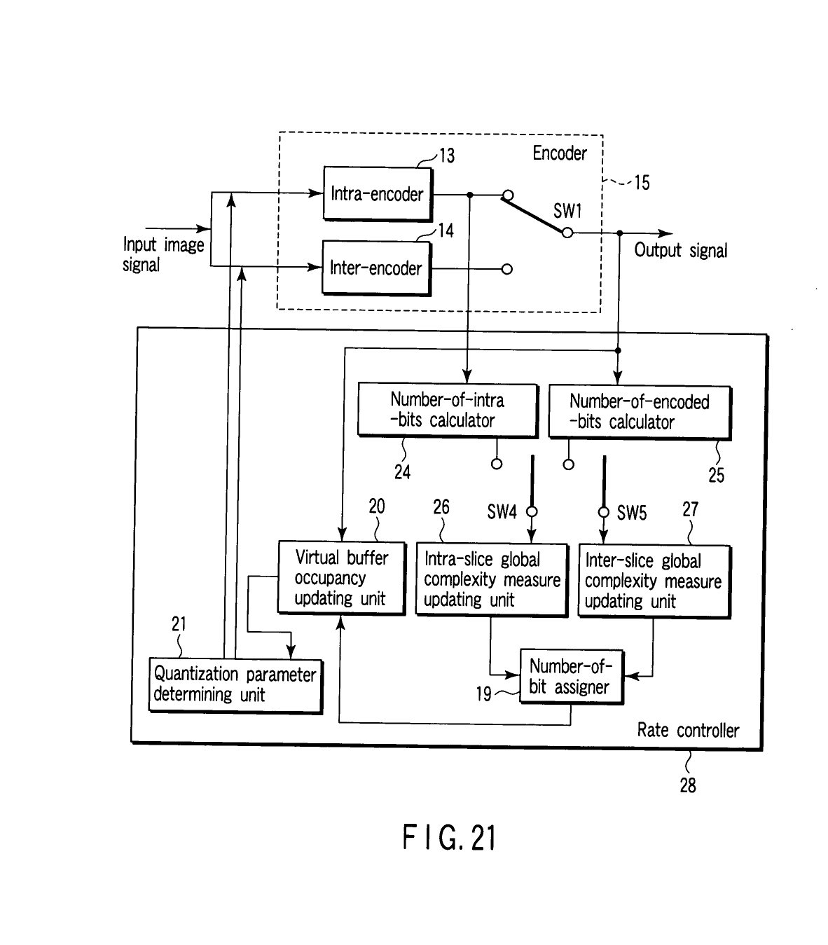

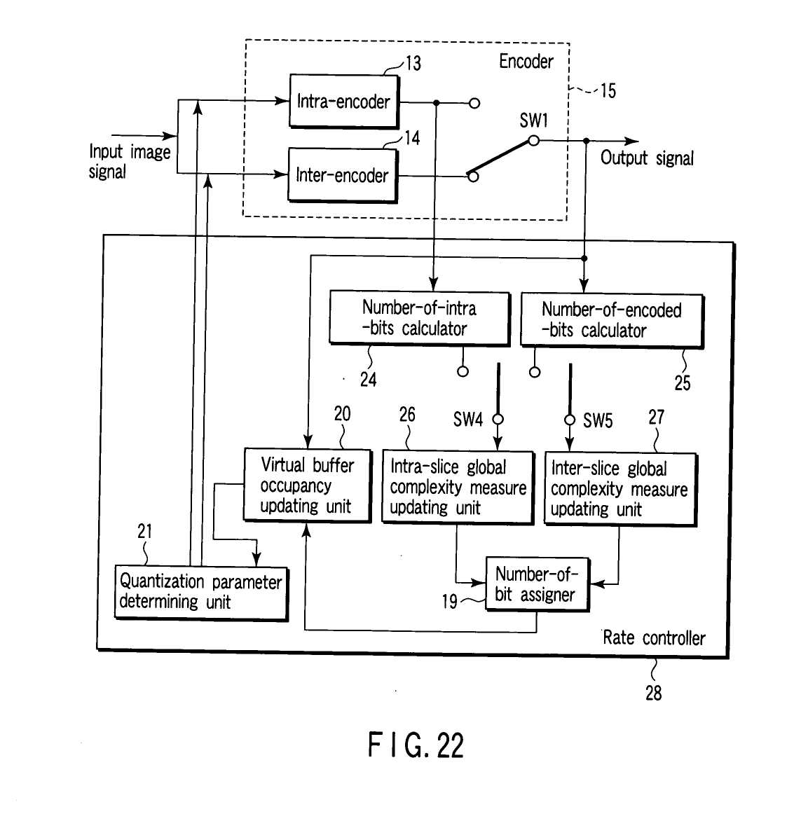

At the time of encoding an inter-slice, an encoding mode in encoding unit is selected from an intra-encoding mode and an inter-encoding mode at the encoder 15 (step S25). It is checked whether or not an intra-encoding mode is selected in step S25 (step S26). When an intra-encoding mode is selected, the switch SW1 is connected to the output of the intra-encoder 13 as shown in FIG. 21 (step S27). When an inter-encoding mode is selected, the switch SW1 is connected to the output of the inter-encoder 14 as shown in FIG. 22 (step S28).

In step S27, as shown in FIG. 21, a result of intra-encoding is taken out as an output signal from the encoder 15, and information on the numbers of encoded bits of encoding units at the time of intra-encoding are inputted to the number-of-intra-bits calculator 24, the number-of-encoded-bits calculator 25, and the virtual buffer occupancy updating unit 20. In step S28, as shown in FIG. 22, a result of inter-encoding is taken out as an output signal from the encoder 15, and information on the numbers of encoded bits of encoding units at the time of inter-encoding are inputted to the number-of-encoded-bits calculator 25 and the virtual buffer occupancy updating unit 20.

Next, in the virtual buffer occupancy updating unit 20, a virtual buffer occupancy is updated in accordance with the number of bits assigned to a current slice by the number-of-bit assigner 19, and the information on the numbers of bits of encoding units from the encoder 15 (step S29). A quantization parameter corresponding to an encoding unit to be encoded next at the encoder 15 is determined on the basis of a value of the virtual buffer occupancy updated in step S29 (step S30). Processing in steps S29 and S30 will be complemented later. The processing in steps S23 to S30 described above are carried out with respect to all the encoding units in the slice of the object video image.

Next, the information on the numbers of encoded bits of encoding units at the time of intra-encoding and inter-encoding are received at the number-of-encoded-bits calculator 25 from the encoder 15, and the number of encoded bits every slice is calculated by adding all the numbers of encoded bits of encoding units in the slice (step S31). Moreover, in the number-of-intra-bits calculator 24, the number of encoded bits at the time of intra-encoding every slice is calculated by adding (summing up) all the numbers of bits of encoding units at the time of intra-encoding in the slice on the basis of the information on the numbers of encoded bits of encoding units at the time of intra-encoding from the encoder 15 (step S32).

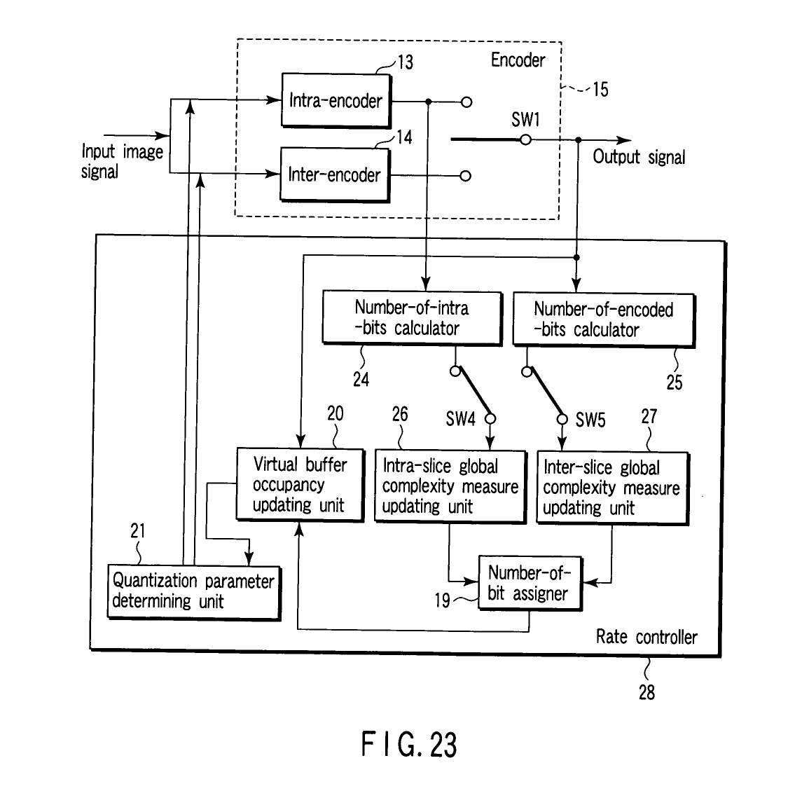

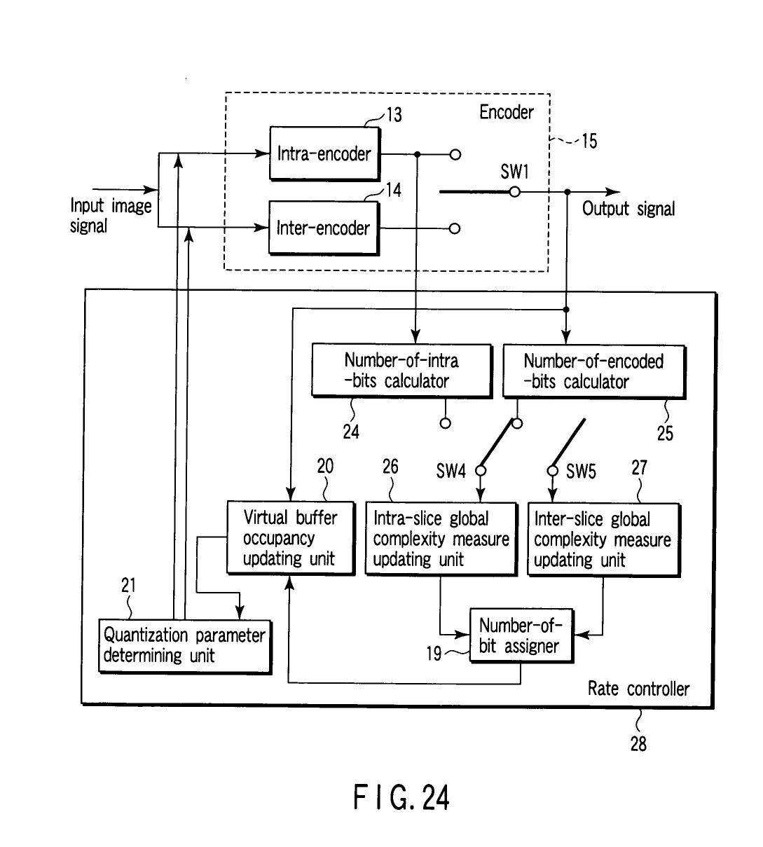

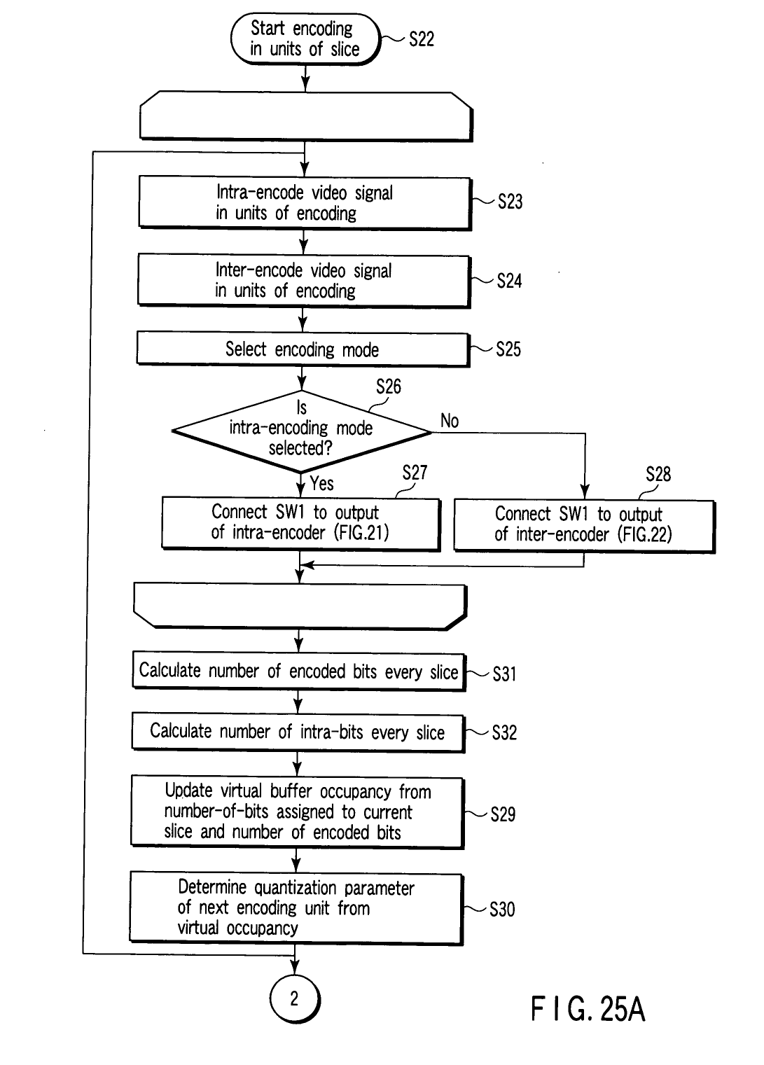

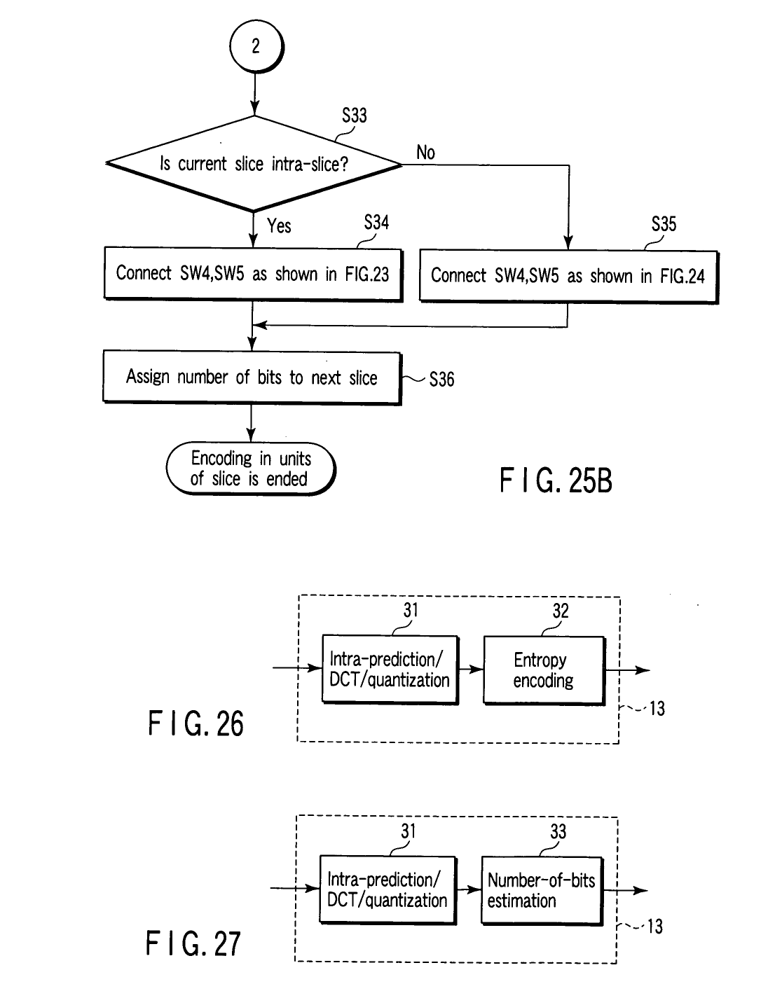

Subsequently, it is judged whether a current slice is an intra-slice or an inter-slice (step S33). When a current slice is an inter-slice as a result of judgment in step S33, the switch SW4 is set such that an output of the number-of-intra-bits calculator 24 is inputted to the intra-slice global complexity measure updating unit 26, and the switch SW5 is set such that an output of the number-of-encoded-bits calculator 25 is inputted to the inter-slice global complexity measure updating unit 27, as shown in FIG. 23 (step S34). The intra-slice global complexity measure updating unit 26 updates an intra-slice global complexity measure in accordance with the number of intra bits every slice calculate by the number-of-intra-bits calculator 24. The inter-slice global complexity measure updating unit 27 updates an inter-slice global complexity measure in accordance with the number of encoded bits every slice calculate by the number-of-encoded-bits calculator 25.

An inter-slice includes a P slice in which motion compensation prediction is carried out on the basis of one reference frame, and a B slice in which motion compensation prediction is carried out on the basis of two reference frames. Here, those are called inter-slices with no distinction between the P slice and B slice. However, respective global complexity measures of the P slice and B slice may be separately updated in the inter-slice global complexity measure updating unit 27. In this case, in the number-of-bit assigner 19, the number of bits is assigned every B slice and every P slice by utilizing each global complexity measure of the P slice and B slice. A case is possible in which a plurality of global complexity measures are managed such that inter-slices are grouped according to a size of a variance value of predictive errors to carry out holding, updating, and referring of the global complexity measures every group. In this way, a usage of inter-slice global complexity measures in the present embodiment is not limited to a specific method.

On the other hand, when a current slice is an intra-slice as a result of judgment in step S33, the switch SW4 is set such that an output of the number-of-encoded-bits calculator 25 is inputted to the intra-slice global complexity measure updating unit 26, as shown in FIG. 24 (step S35). The intra-slice global complexity measure updating unit 26 updates the intra-slice global complexity measures on the basis of the number of encoded bits every slice calculated by the number-of-encoded-bits calculator 25. At this time, SW5 is set such that an output of the number-of-encoded-bits calculator 25 is not inputted to the inter-slice global complexity measure updating unit 27. Accordingly, updating of the inter-slice global complexity measures is not carried out.

Here, the inter-slice and intra-slice global complexity measures may be updated in accordance with a model for use in a rate control system, and a model for updating is not limited in particular. For example, in TM5 employed in MPEG-2, the global complexity measures are updated by using a relational expression of [global complexity measure=number of encoded bits×quantization parameter] for each of the I picture, P picture, and B picture. In FIGS. 17, and 21 to 24, the inter-slice global complexity measure updating unit 27 is expressed so as to be one component. However, the inter-slice global complexity measure updating unit 27 includes a function of separately updating the global complexity measures for each of the picture types having different relationships between the number of encoded bits and the quantization parameter.

Next, the number of bits assigned to a slice to be encoded next is determined in the number-of-bit assigner 19 (step S36). In this case, there are utilized the global complexity measures updated in the intra-slice global complexity measure updating unit 26 and the inter-slice global complexity measure updating unit 27. For example, when the inter-slice global complexity measure is greater than the intra-slice global complexity measure, a large number of bits is assigned by an inter-encoded picture, and in reverse case, a large number of bits is assigned by an intra-encoded picture.

For example, in TM5 for use in MPEG-2, the numbers of bits TI, TP and TB which are respectively assigned to the I picture, P picture, and B picture are calculated as follows.

$$\begin{matrix}{T}_{I} = \frac{R}{1 + \frac{{N}_{p} {X}_{p}}{{X}_{I} {K}_{p}} + \frac{{N}_{B} {X}_{B}}{{X}_{I} {K}_{B}}} \\ {T}_{p} = \frac{R}{{N}_{p} + \frac{{N}_{B} {K}_{P} {X}_{B}}{{K}_{B} {X}_{P}}} \\ {T}_{B} = \frac{R}{{N}_{B} + \frac{{N}_{P} {K}_{B} {X}_{P}}{{K}_{P} {X}_{B}}}\end{matrix} \} \qquad ( 13 )$$

where, XI, XP and XB respectively show global complexity measures for I picture, P picture, and B picture; NP and NB respectively show the number of P pictures and the number of B pictures which are remaining up to the next I pictures; and R shows the number of bits to be assigned up to the next I picture. KP and KB respectively show constants depending on the quantization, and for example, KP=1.0, and KB=1.4.

The virtual buffer occupancy updating unit 20 updates a virtual buffer occupancy by accumulating a difference between the number of bits assigned by the number-of-bit assigner 19 and the number of encoded bits as a virtual buffer occupancy. This processing is shown in step S29 of FIG. 18A. When the difference accumulated with respect to the encoded pictures is a positive value, it shows that bits are generated so as to be beyond an assigned amount.

Subsequently, in the quantization parameter determining unit 21, a quantization parameter is determined by inputting the updated virtual buffer occupancy. Namely, when a virtual buffer occupancy is made greater, a quantization parameter is made greater so as to decrease the number of encoded bits of the next picture. When a virtual buffer occupancy is little, on the other hand, a quantization parameter is made smaller so as to increase the number of encoded bits of the next picture. This processing is shown in step S30 of FIG. 18A. The quantization parameter determined in this way is used at the time of encoding the next encoding unit. As a result, rate control is carried out such that the number of encoded bits of the entire sequence of the object video image is made close to a target number of bits.

Here, there are both cases in which a slice unit in which the number of bits is assigned, and a unit in which a virtual buffer occupancy is updated, and a quantization parameter is changed by feeding back the virtual buffer occupancy are the same, and are different from each other. When a unit in which the number of bits is assigned, and a unit in which a quantization parameter is changed by feedback control are different from one another, there are conceived, for example, (a1) assignment of the number of bits is carried out per picture (in this case, a slice in the above description is a picture), (a2) encoding is carried out every macro block in a picture (16 pixels×16 pixels shown by one square in FIG. 19), (a3) a virtual buffer occupancy is updated every macro block, and (a4) a quantization parameter is determined every macro block. The flow of processing in this case may be in FIGS. 18A and 18B. Further, there are conceived (b1) assignment of the number of bits is carried out in units of one line (the shaded portion or the other portion) of FIG. 20 (in this case, a slice is this one line), (b2) encoding is carried out every macro block in each line, (b3) a virtual buffer occupancy quantity is updated every macro block, and (b4) a quantization parameter is determined every macro block. Moreover, there are conceived (c1) assignment of the number of bits is carried out per picture, (c2) encoding is carried out every macro block, (c3) a virtual buffer occupancy quantity is updated in units of one line of FIG. 20, and (c4) a quantization parameter is determined in units of one line.

On the other hand, when a unit in which the number of bits is assigned, and a unit in which a quantization parameter is changed by feedback control are the same, there are conceived (d1) assignment of the number of bits is carried out per picture, (d2) encoding is carried out every macro block, (d3) a virtual buffer occupancy is updated per picture, and (d4) a quantization parameter is determined per picture. The flow of processings in this case is in FIGS. 25A and 25B. In FIGS. 18A to 18B and FIGS. 25A and 25B, the positions of the step of updating a virtual buffer occupancy S29 and the step of determining a quantization parameter S30 are different from one another. However, the present invention does not depend on those positions, and any case can be applied thereto. A unit in which the number of bits is assigned, and a unit in which a quantization parameter is changed by feedback control can be arbitrarily changed.

In accordance with the present embodiment, the intra-slice global complexity measure is updated every slice, so that a frequency of updating is made higher. Accordingly, there is less divergence from an optimal value of the intra-slice global complexity measure. In the prior art, the intra-slice global complexity measure is updated only in an intra-slice encoding mode. Therefore, an accuracy of updating is made lower when the characteristics of intra-slice images before and after updating are different greatly, and there is a deterioration in the image quality in some cases. In contrast thereto, in accordance with the present embodiment, the intra-slice global complexity measure is updated at the time of inter-slice as well, whereby a change in the characteristics of intra-slice images before and after updating is made less. Accordingly, an accuracy of updating is improved, which makes a deterioration in the image quality less.

In the encoder 15 in FIG. 17, an optimal encoding mode is selected every macro block by the switch SW1. In a modified example of the sixth embodiment of the invention, rate control is carried out as follows when the switch SW1 selects an optimal encoding mode. The slice-specific number-of-intra-bits calculator 24 calculates the number of encoded bits every intra-slice by determining and summing up the encoded bits per macro block when the intra-encoder 13 carries out intra-encoding with respect to an input video image signal. The intra-slice global complexity measure updating unit 26 updates an intra-slice global complexity measure on the basis of the added number of encoded bits every intra-slice, and the encoder 15 carries out rate control on the basis thereof.

(Seventh Embodiment)

In the sixth embodiment, the intra-encoder 13 is, as shown in FIG. 26, configured by an intra-prediction/DCT/quantization unit 31, and an entropy encoder 32 which encodes a quantized DCT coefficient (orthogonal transformed coefficient). In contrast thereto, in a video encoding apparatus according to a seventh embodiment of the present embodiment, an intra-encoder 13 has, as shown in FIG. 27, an intra-prediction/DCT/quantization unit 31, and a number-of-bits estimating unit 33 which estimates the number of encoded bits on the basis of a quantized DCT coefficient, and a entropy encoder 32 is not included therein.

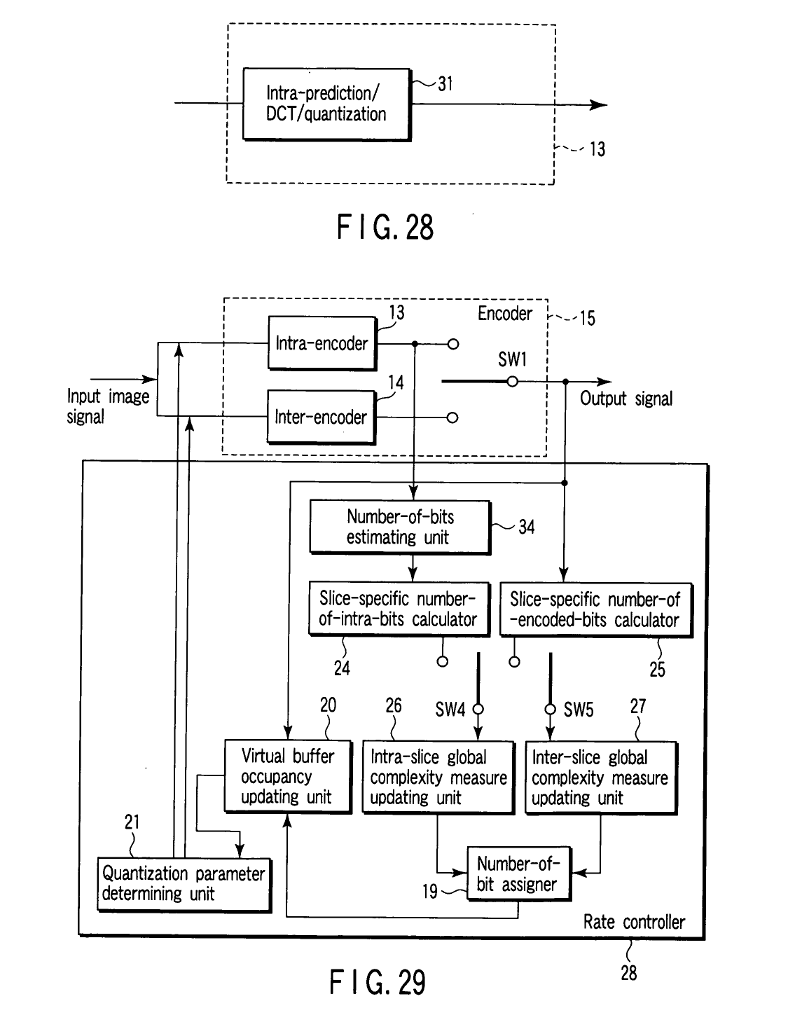

As a modified example of the seventh embodiment, only the intra-prediction/DCT/quantization unit 31 is provided in the intra-encoder 13 as shown in FIG. 28, and a number-of-bits estimating unit 34 may be disposed before the number-of-encoded-bits calculator 25, as shown in FIG. 29. In this case as well, the entropy encoder 32 is not included in the intra-encoder 13.

The number-of-bits estimating units 33 and 34 estimate the number of bits per encoding unit, and the slice-specific number-of-encoded-bits calculator 25 calculates the number of encoded bits every slice by adding estimated numbers of encoded bits per encoding unit.

As described in the first embodiment, in addition to a method for checking the number of encoded bits on the basis of a result of entropy encoding, a method is also reported in which the number of encoded bits is estimated on the basis of the number of zero coefficients at the time of quantizing a DCT coefficient obtained by DCT transform which is at the middle stage of encoding (for example, in “Reference Document 2” described above). Also, a modified example is possible in which the number of encoded bits is estimated by using this, and it is inputted to the number-of-intra-bits calculator 24 to be used for updating the intra-slice global complexity measure. In this modified example, processing other than the part in which the number of encoded bits is estimated in the process of calculating a number of intra-bits every slice from the intra-encoder 13 may be the same as those in the sixth embodiment.

The video encoding processing based on the embodiments of the invention described above can be realized by hardware. However, it can be executed by software by using a computer such as a personal computer. According to the present invention, a program as quoted hereinafter or a storage medium having the program stored therein, which is readable by a computer can be provided.

Note that the present invention is not limited to the above-described embodiments as are, and the structural elements can be modified and embodied within a range which does not deviate from the gist of the present invention at the stage of implementing the invention. Further, various inventions can be formed by appropriately combining a plurality of the structural elements disclosed in the above-described embodiments. For example, some structural elements may be eliminated from all the structural elements shown in the embodiments.

Moreover, structural elements over different embodiments may be combined appropriately. Because it is possible to set a quantization parameter suitable for a characteristic of an object video image, the image quality of an encoded image is improved. An increase in an encoding time can be avoided by carrying out analyzes, not onto the entire object video image, but onto limited n pictures. Accordingly, it is possible to apply the present invention to image data on the air or the like, with only a delay of an encoding time by n pictures.

Further, because it is possible to set a quantization parameter suitable for a characteristic of an image after a scene change every scene change, the image quality after a scene change is improved.

Moreover, a frequency of updating a global complexity measure for intra-encoding is made frequent, and an accuracy of updating is made higher, whereby it is possible to reduce a deterioration in the image quality in an image whose complexity varies.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A video encoding method comprising:
encoding n pictures included in a video image using a first quantization parameter to generate first encoded data;
calculating first number-of-encoded-bits information indicating number of encoded bits of every picture type used for the encoding, using the first encoded data;
multiplexing a set frame rate by an average first-number-of-encoded-bits per picture which is calculated from the first-number-of-encoded-bits information to obtain a first bit rate;
encoding the n pictures included in the object video image using a second quantization parameter different from the first quantization parameter to generate second encoded data;
calculating second number-of-encoded-bits information indicating number of encoded bits of every picture type used for the latter encoding, using the second encoded data;
multiplexing the set frame rate by an average second number-of-encoded-bits per picture which is calculated from the first-number-of-encoded-bits information to obtain a second bit rate;
calculating a third quantization parameter, using the first bit rate, the first quantization parameter, the second bit rate, the second quantization parameter and the target bit rate; and
performing a rate control using the third quantization parameter as an initial value so that a bit rate of encoded data nears a target bit rate.

2. A video encoding apparatus comprising:
an encoder to encode n pictures included in a video image using a first quantization parameter and a second quantization parameter different from the first quantizaion parameter to generator first encoded data and second encoded data;
a first calculator to calculate first number-of-encoded-bits information and second number-of-encoded-bits information using the first encoded data and the second encoded data, respectively, the first number-of-encoded-bits information indicating number of encoded bits of every picture type used for encoding the video image using the first quantization parameter and the second number-of-encoded-bits information indicating number of encoded bits of every picture type used for encoding the video image using the second quantization parameter;
a second calculator to multiplex a set frame rate by an average first-number-of-encoded-bits per picture which is calculated from the first-number-of-encoded-bits information, to obtain a first bit rate;
a third calculator to multiplex the set frame rate by an average second number-of-encoded-bits per picture which is calculated from the second-number-of-encoded-bits information, to obtain a second bit rate; and
a fourth calculator to calculate a third quantization parameter, using the first bit rate, the first quantization parameter, the second bit rate, the second quantization parameter and the target bit rate, and wherein
the encoder encodes the video image while performing a rate control using the third quantization parameter as an initial value so that a bit rate of encoded data nears a target bit rate.

3. The video encoding apparatus according to claim 2, wherein the fourth calculator calculates the third quantization parameter by following equation:
$$QP = \frac{QP 2 - QP 1}{log ( BR 2 ) - log ( BR 1 )} ⨯ log ( BR ) + \frac{QP 1 \cdot log ( BR 2 ) - QP 2 \cdot log ( BR 1 )}{log ( BR 2 ) - log ( BR 1 )}$$
where QP1 indicates the first quantization parameter, QP2 the second quantization parameter, QP the third quantization parameter, BR1 the first bit rate, BR2 the second bit rate, BR the target bit rate.

4. The video encoding apparatus according to claim 2, wherein the fourth calculator calculates the third quantization parameter every scene change of the object video.

5. The video encoding apparatus according to claim 2, wherein the encoder encodes the video image by a plurality of picture types, and the first calculator calculates the first number of encoded bits per picture and the second number of encoded bits per picture when the n pictures (n≧2) are encoded, and third number-of-encoded-bits information indicating number of encoded bits of every picture type when the n pictures are encoded using the third quantization parameter; and which further comprises:
an image complexity degree index calculator to calculate an image complexity degree index by picture type according to a ratio of the third number-of-encoded-bits information; and
a rate controller to do the rate control using the image complicated degree index by the picture type as the initial value.

6. The video encoding apparatus according to claim 5, wherein the image complicated degree index calculator calculates an image complexity degree index by picture type for every scene change of the object image.

7. The video encoding apparatus according to claim 5, further comprising:
an update unit configured to update the image complicated degree index by picture type according to an update equation having a constant number parameter;
a constant number parameter calculator to calculate the constant number parameter for every picture type from the first number-of-encoded-bits information, the first quantization parameter, the second number-of-encoded-bits information and the second quantization parameter.

8. The video encoding apparatus according to claim 7, wherein the update type is following equation:
$$\begin{matrix}{X}_{i} = {S}_{i} \cdot {C}_{I}^{{Q}_{i}} \\ {X}_{p} = {S}_{p} \cdot {C}_{P}^{{Q}_{p}} \\ {X}_{b} = {S}_{b} \cdot {C}_{B}^{{Q}_{b}}\end{matrix} \}$$
where Xi, Xp and Xb indicate image complexity degree indexes of I, P and B pictures, respectively, Si, Sp and Sb the number of encoded bits of I, P and B pictures, respectively, and CI, CP and CB the constant number parameters, respectively, and the parameters CI, CP and CB are calculated by following equation:
$$\begin{matrix}{C}_{I} = {2}^{\frac{log ( I 1 ) - log ( I 2 )}{Q 2 - Q 1}} \\ {C}_{P} = {2}^{\frac{log ( P 1 ) - log ( P 2 )}{Q 2 - Q 1}} \\ {C}_{B} = {2}^{\frac{log ( B 1 ) - log ( B 2 )}{Q 2 - Q 1}}\end{matrix} \}$$
QP1 indicates the first quantization parameter, QP2 the second quantization parameter, I1, P1 and B1 the first number-of-bits by picture types of I, P and B pictures, I2, P2 and B2 the second number-of-bits by picture types of I, P and B pictures.

9. The video encoding apparatus according to claim 7, wherein the constant number parameter calculator calculates a constant number parameter for every scene change of the object video.

10. A video encoding method for encoding a video image, comprising:
encoding a video image according to an inter-encoding mode and an intra-encoding mode;
calculating number of encoded bits when a to-be-encoded picture of the video image is encoded by an intra-encoding mode;
updating an image complicated degree index concerning the intra-encoding mode using the number of encoded bits; and
performing a rate control using the image complicated degree index so that a bit rate of encoded data nears a target bit rate.

11. A video encoding apparatus of encoding a video image, comprising:
an encoder to encode a video image according to an inter-encoding mode and an intra-encoding mode;
a calculator to calculate number of encoded bits when a to-be-encoded picture of the video image is encoded by an intra-encoding mode; and
an updating unit configured to update an image complicated degree index concerning the intra-encoding mode using the number of encoded bits, and wherein
the encoder encode the video image while performing a rate control using the image complicated degree index so that a bit rate of encoded data nears a target bit rate.

12. The video encoding apparatus according to claim 11, which further comprises a selector to select an optimum one of the inter-encoding mode and the intra-encoding modes for every macroblock of the video image when the encoder encodes the video image while doing the rate control using the image complicated degree index, and wherein when the selector selects the encoding mode which is optimum, the calculator sums up the number of encoded bits units of macroblock when the to-be-encoded picture of the video image is encoded by the intra-encoding mode, the updating unit updates the image complexity degree index concerning the intra-encoding mode using the summed number of encoded bits.

13. The video encoding apparatus according to claim 11, which further comprises:
a selector to select an optimum one of the inter-encoding mode and the intra-encoding modes for every macroblock of the video image when the encoder encodes the video image while doing the rate control using the image complicated degree index; and
a number-of-encoded-bits estimator to estimate the number of encoded bits units of macroblock when the to-be-encoded picture of the video image is encoded by the intra-encoding mode when the selector selects the encoding mode which is optimum, and wherein
the number of encoded bits calculator sums up the number of encoded bits per macroblock, and the image complicated degree index update unit updates the image complexity degree index concerning the intra-encoding mode using the summed number of encoded bits.

14. The video encoding apparatus according to claim 13, wherein the encoded comprises a quantizer to quantize an orthogonal transformation coefficient, and the estimator estimates the number of encoded bits every encoding using the orthogonal transformation coefficient, and sum up them.

15. A video encoding program recorded on a computer readable medium for encoding a video image, comprising:
means for instructing a computer to encode n pictures included in a video image using a first quantization parameter to generate first encoded data;
means for instructing the computer to calculate first number-of-encoded-bits information indicating number of encoded bits of every picture type used for the encoding, using the first encoded data;
means for instructing the computer to multiplex a set frame rate by an average first-number-of-encoded-bits per picture which is calculated from the first-number-of-encoded-bits information to obtain a first bit rate;
means for instructing the computer to encode the n pictures included in the object video image using a second quantization parameter different from the first quantization parameter to generate second encoded data;
means for instructing the computer to calculate second number-of-encoded-bits information indicating number of encoded bits of every picture type used for the latter encoding, using the second encoded data;
means for instructing the computer to multiplex the set frame rate by an average second number-of-encoded-bits per picture which is calculated from the first-number-of-encoded-bits information to obtain a second bit rate;
means for instructing the computer to calculate a third quantization parameter, using the first bit rate, the first quantization parameter, the second bit rate, the second quantization parameter and the target bit rate; and
means for instructing the computer to perform a rate control using the third quantization parameter as an initial value so that a bit rate of encoded data nears a target bit rate.

16. A video encoding program recorded on a computer readable medium for encoding a video image, comprising:
means for instructing a computer to encode a video image according to an inter-encoding mode and an intra-encoding mode;
means for instructing the computer to calculate number of encoded bits when a to-be-encoded picture of the video image is encoded by an intra-encoding mode;
means for instructing the computer to update an image complicated degree index concerning the intra-encoding mode using the number of encoded bits; and
means for instructing the computer to perform a rate control using the image complicated degree index so that a bit rate of encoded data nears a target bit rate.

17. A video encoding method comprising:
encoding n pictures included in a video image using each of provisional quantization parameters of different values;
calculating number-of-encoded-bits information indicating number of encoded bits of every picture type used for the encoding with respect to each of the provisional quantization parameters;
multiplexing a set frame rate by an average first-number-of-encoded-bits per picture which is calculated from the provisional number-of-encoded-bits information to obtain a provisional bit rate concerning each provisional quantization parameter;
calculating an initial parameter of the quantization parameter, using the provisional quantization parameter, the provisional bit rate concerning each of the provisional quantization parameters, and the target bit rate; and
performing a rate control using the initial parameter so that a bit rate of encoded data nears a target bit rate.

18. A video encoding apparatus comprising:
an encoder to encode n pictures included in a video image using each of provisional quantization parameters of different values;
a calculator to calculate number-of-encoded-bits information indicating number of encoded bits of every picture type used for the encoding with respect to each of the provisional quantization parameters;
a calculator to multiplex a set frame rate by an average first-number-of-encoded-bits per picture which is calculated from the provisional number-of-encoded-bits information to obtain a provisional bit rate concerning each provisional quantization parameter; and
a calculator to calculate an initial parameter of the quantization parameter, using the provisional quantization parameter, the provisional bit rate concerning each of the provisional quantization parameters, and the target bit rate, and wherein
the encoder encodes the video image while performing a rate-control using the initial parameter so that a bit rate of encoded data nears a target bit rate.
